(19) United States
(12) Patent Application Publication
(10) Pub. No.: US 2021/0247762 A1
(43) Pub. Date: Aug. 12, 2021

(54) Allocating Vehicle Computing Resources to One or More Applications

(71) Applicant: QUALCOMM Incorporated., San Diego, CA (US)

(72) Inventors: Hee Jun PARK, San Diego, CA (US); Ronald ALTON, Oceanside, CA (US)

(21) Appl. No.: 16/788,700

(22) Filed: Feb. 12, 2020

(51) Int. Cl. G05D 1/00; B60W 40/09; G06K 9/62

(52) U.S. Cl. CPC G05D 1/0055; G05D 2201/0213; G06K 9/6288; B60W 40/09

(57) ABSTRACT

Embodiments include methods performed by a processor of a vehicle. The processor may determine a priority to safe vehicle operations of each of a plurality of vehicle applications based on relative impacts on driver performance of safety-related tasks under one or more current vehicle conditions. The processor may determine a driver-performance-safety factor for each of the plurality of vehicle applications. The processor may allocate computing resources to each of the plurality of vehicle applications based on the determined driver-performance-safety factor of each vehicle application.

### BACKGROUND

The level of automation, computer-assistants and entertainment systems in automobiles and trucks is ever increasing as the industry moves towards selling vehicles with sophisticated driver aids. Computing system deployed in vehicles are being given the ability to analyze the environment in and around the vehicle and make various decisions affecting vehicle operation. However, even in the most modern vehicle computing systems, processing resources are finite, and may be limited in utilization or operating frequency, peak current capability, or thermal resource limits. Conventional methods of managing computing resources to avoid exceeding various operating limits on vehicle computing systems include reducing or limiting processing resources for selected processor cores and/or applications, or shutting down or pausing applications. However, shutdown or paused applications provide no functionality, whereas reducing a processor operating frequency can cause performance degradation even in safety-critical applications.

### SUMMARY

Various aspects include methods that may be implemented in a processing device within a vehicle for allocating computing resources to vehicle applications executing on a computing device of the vehicle.

Various aspects may include determining a driver-performance-safety factor for each of a plurality of vehicle applications, wherein the driver-performance-safety factor reflects a predicted relative impact on a safety-related driving task of reducing computing resources to a given vehicle application, and allocating computing resources to each of the plurality of vehicle applications based on the determined driver-performance-safety factor of each vehicle application.

In some aspects, determining the driver-performance-safety factor for each of the plurality of vehicle applications may include determining the driver-performance-safety factor for each of the plurality of vehicle applications based on a priority to safe vehicle operations of each of the plurality of vehicle applications. In some aspects, determining the driver-performance-safety factor for each of the plurality of vehicle applications may include determining a level of utility of each vehicle application to human performance of the safety-related driving task.

In some aspects, determining the driver-performance-safety factor for each of the plurality of vehicle applications may include, determining a reduced overall driving safety quotient, and determining for each of the plurality of vehicle applications a performance delivery rate for the application that satisfies the reduced overall driving safety quotient, and allocating computing resources to each of the plurality of vehicle applications may include implementing in each of the plurality of vehicle applications operating parameters and functionality elements that provide the performance delivery rate for each vehicle application.

In some aspects, determining the driver-performance-safety factor for each of the plurality of vehicle applications may include accessing a database of driver-performance-safety factors generated by assessing, for a plurality of drivers, relative impacts on driver performance of the safety-related driving task at a plurality of different levels of reduced computing resources, and determining one of average or worst-case impacts for each of the plurality of different levels of reduced computing resources.

In some aspects, determining the driver-performance-safety factor for each of the plurality of vehicle applications may include using a formula for estimating a relative impact of reducing computing resources to a given vehicle application on human performance of the safety-related driving task, wherein the formula is generated by determining a formula that encompasses relative impacts on human performance of the safety-related driving task at a plurality of different levels of reduced computing resources for a plurality of drivers.

In some aspects, the one or more vehicle conditions may include one or more of an in-cabin condition and an external condition, and determining the driver-performance-safety factor for each of the plurality of vehicle applications may include determining the driver-performance-safety factor for each of the plurality of vehicle applications based on one or more of an in-cabin condition and an external condition.

Some aspects may further include determining a utilization of total computing resources, and allocating computing resources to each of the plurality of vehicle applications may include allocating computing resources to each of the plurality of vehicle applications based on the determined driver-performance-safety factor of each vehicle application, and the determined utilization of total computing resources.

Some aspects may further include determining whether a temperature of the processor meets a temperature threshold, and reducing total computing resources in response to determining that the temperature of the processor meets the temperature threshold. In such aspects, allocating computing resources to each of the plurality of vehicle applications may include allocating computing resources to each of the plurality of vehicle applications based on the determined driver-performance-safety factor of each vehicle application, and the reduced total computing resources.

Further aspects include a vehicle including a processor configured with processor-executable instructions to perform operations of any of the methods summarized above. Further aspects include a non-transitory processor-readable storage medium having stored thereon processor-executable software instructions configured to cause a processor to perform operations of any of the methods summarized above. Further aspects include a processing device for use in a vehicle and configured to perform operations of any of the methods summarized above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of the various embodiments.

FIGS. 1A and 1B are component block diagrams illustrating a vehicle suitable for implementing various embodiments.

FIG. 1C is a component block diagram illustrating components of a vehicle suitable for implementing various embodiments.

FIG. 2A is a component block diagram illustrating components of an example vehicle management system according to various embodiments.

FIG. 2B is a component block diagram illustrating components of another example vehicle management system according to various embodiments.

FIG. 3 is a block diagram illustrating components of an example system on chip for use in a vehicle according to various embodiments.

FIG. 4 is a component block diagram of an example system configured for allocating computing resources to an application performed by a processor of a vehicle.

FIG. 5A is a graph and illustration of an example driving safety quotient to performance delivery rate curve illustrating examples of changes in supported functionality of a navigation application that can implemented in response to reductions in allocated computing resources.

FIGS. 5B and 5C are notional graphs of application driver-performance-safety factors over resource allocation illustrating aspects of a method of allocating computing resources to an application in accordance with various embodiments.

FIG. 5D is a process flow diagram illustrating operations of a method for determining allocations of computing resources to individual vehicle applications to achieve an overall reduction in employed computing resources in accordance with various embodiments.

FIG. 6 is a process flow diagram illustrating operations of a method for allocating computing resources to an application performed by a processor of a vehicle according to various embodiments.

FIGS. 7A-7F are process flow diagrams illustrating operations that may be performed by a processor of a vehicle as part of a method for allocating computing resources to an application performed by a processor of a vehicle according to various embodiments.

FIG. 8 is a process flow diagram an example method for determining the average or worst-case impact on driver performance of vehicle safety-related tasks of allocating different levels of computing resources to each of a plurality of vehicle operations to generate a database, data table or parametric equation suitable for use with various embodiments.

### DETAILED DESCRIPTION

Various aspects will be described in detail with reference to the accompanying drawings. Wherever possible, the same reference numbers will be used throughout the drawings to refer to the same or like parts. References made to particular examples and embodiments are for illustrative purposes and are not intended to limit the scope of the various aspects or the claims.

Various aspects include methods and vehicle computing systems implementing the methods when necessary to avoid exceeding processor limits for selectively reducing processing resources to vehicle application based at least in part on relative effects on driver performance of safety tasks, particularly in view of current operating, internal and external conditions. Thus, instead of limiting resources to applications based on an arbitrary ranking or priority, computing resource allocations take into account how reducing resources to various applications could affect the driver's ability to safely operate the vehicle.

The surface transportation industry has increasingly looked to leverage the growing capabilities of cellular and wireless communication technologies through the adoption of Intelligent Transportation Systems (ITS) technologies to increase intercommunication and safety for both driver-operated vehicles and autonomous vehicles. The cellular vehicle-to-everything (C-V2X) protocol defined by the 3rd Generation Partnership Project (3GPP) supports ITS technologies and serves as the foundation for vehicles to communicate directly with the communication devices around them.

C-V2X defines two transmission modes that, together, provide a 360° non-line-of-sight awareness and a higher level of predictability for enhanced road safety and autonomous driving. A first transmission mode includes direct C-V2X, which includes vehicle-to-vehicle (V2V), vehicle-to-infrastructure (V21), and vehicle-to-pedestrian (V2P), and that provides enhanced communication range and reliability in the dedicated ITS 5.9 gigahertz (GHz) spectrum that is independent of a cellular network. A second transmission mode includes vehicle-to-network communications (V2N) in mobile broadband systems and technologies, such as third generation wireless mobile communication technologies (3G) (e.g., global system for mobile communications (GSM) evolution (EDGE) systems, code division multiple access (CDMA) 2000 systems, etc.), fourth generation wireless mobile communication technologies (4G) (e.g., long term evolution (LTE) systems, LTE-Advanced systems, mobile Worldwide Interoperability for Microwave Access (mobile WiMAX) systems, etc.), fifth generation wireless mobile communication technologies (5G) (e.g., 5G New Radio (5G NR) systems, etc.), etc.

The term “system-on-chip” (SOC) is used herein to refer to a set of interconnected electronic circuits typically, but not exclusively, including one or more processors, a memory, and a communication interface. The SOC may include a variety of different types of processors and processor cores, such as a general purpose processor, a central processing unit (CPU), a digital signal processor (DSP), a graphics processing unit (GPU), an accelerated processing unit (APU), a sub-system processor, an auxiliary processor, a single-core processor, and a multicore processor. The SOC may further embody other hardware and hardware combinations, such as a field programmable gate array (FPGA), a configuration and status register (CSR), an application-specific integrated circuit (ASIC), other programmable logic device, discrete gate logic, transistor logic, registers, performance monitoring hardware, watchdog hardware, counters, and time references. SOCs may be integrated circuits (ICs) configured such that the components of the ICs reside on the same substrate, such as a single piece of semiconductor material (e.g., silicon, etc.).

As used herein, the terms “component,” “system,” “unit,” “module,” and the like include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a communication device and the communication device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

Vehicle processing resources are finite and limited for various reasons. For example, processing resources may be limited by a thermal power envelope or a thermal resource limit. When necessary to avoid exceeding various operating limits on vehicle computing systems (e.g., temperature), processing resources (e.g., power, operating frequency) may be reduced or limited for selected processor cores and/or applications. The current capability of a system power supply or chipset power management integrated circuit also may be limited. Some conventional solutions may guarantee computing resources for a small number of high priority applications by shutting down or temporarily pausing lower priority applications. The shutdown or paused applications provide no functionality. Other conventional solutions may reduce an operating frequency in one or more processors, for example, to keep the operating frequency of a processor below a thermal limit Such solutions can cause performance degradation even in safety-critical applications that should remain in use to help drivers safely operate a vehicle. For example, pausing or slowing a vehicle cluster display and other systems important for driving safety could impact a driver's ability to perform some safety related operations.

Various embodiments enable a processor of a vehicle to allocate computing resources to one or more applications executing on the vehicle processor so as to minimize the impact on a vehicle operator's ability to perform safety-related operations (e.g., steering, braking, etc.). Various embodiments enable a vehicle processor to intelligently manage resource allocation and a processing quality of each of a plurality of concurrent automotive applications, processes, or other functions (referred to herein collectively as “applications”). In some embodiments, the processor may allocate finite processing resources to each of a plurality of vehicle applications based on a determination of a priority of each vehicle application to safe vehicle operations in a moment-to-moment, context-determined manner based on internal and external vehicle conditions, and a determination of an impact on a vehicle operator's ability to perform a safety-related driving task from reducing computing resources to particular vehicle applications.

Various embodiments may include determining a priority of each of a plurality of vehicle applications to safe vehicle operations based on one or more vehicle conditions, determining a driver-performance-safety factor for each of the plurality of vehicle applications, and allocating computing resources to each of the plurality of vehicle applications based on the determined driver-performance-safety factor of each vehicle application. The driver-performance-safety factor may reflect a predicted relative impact on a safety-related driving task of reducing computing resources to a given vehicle application, which may be determined based on testing of a plurality of drivers performing safety-related driving tasks which various applications allocated different levels of computing resources.

Vehicle applications may include, for example, a cluster display that generates and presents information such as vehicle speed (i.e., speedometer), selected gear, fuel level, odometer, and the like, often in the form of needle gauges, digital readouts, or other symbols; vehicle location and navigation systems; vehicle path planning and maneuvering systems; vehicle safety features such as lane maintenance, automatic braking, collision sensors, and other similar safety features; a variety of vehicle sensors and the data collected by such sensors; a center display that may, for example, provide driver information as well as access to and control of various vehicle functions; an augmented reality (AR) display or heads-up display (HUD) that may, for example, superimpose digital information on a windshield or window; driver monitoring functions, such as eye tracking, or awakeness or liveness analysis, and other suitable monitoring functions; a passenger display or rear seat display, which may, for example, provide access to various vehicle information and functions; automated exterior lighting systems, such as headlights, fog lights, etc.; and other vehicle applications that could impact the safe operation of a vehicle.

One or more vehicle conditions that may be considered in various embodiments when allocating processing resources to applications may include in-cabin or internal vehicle conditions and external vehicle conditions. Internal vehicle conditions may include, for example, occupancy by one or more passengers; a state or condition of the one or more passengers (such as awake, alert, not alert/attention wandering, asleep, and so forth); one or more driver capabilities (for example, based on a driver's age, apparent reflex capabilities or reaction times, or other measurable driver capabilities); whether a warning or notification is currently triggered and/or displayed for the driver; internal air temperature, humidity, and/or quality; and other internal vehicle conditions that could impact the safe operation of a vehicle. Other internal vehicle conditions may include a distance from a display to a driver's eyes, which may affect a maximum perceptible resolution of the display; a determination of whether a driver is paying attention to or watching a display (for example, by gaze monitoring); and vibrations affecting the driver and/or the vehicle, which may affect a maximum perceptible resolution of a display.

External vehicle conditions that may be considered in various embodiments when allocating processing resources to applications may include a driving speed and direction of the vehicle; road conditions, ambient temperature, ambient humidity, and weather conditions; proximity, speed, and direction of motion of other objects such as vehicles, pedestrians, etc.; an anticipated or planned path of the vehicle; the presence or detection of road hazards, accidents, or other similar threatening conditions; information received from another vehicle (for example, via C-V2X (cellular vehicle-to-everything) or BSM (Basic Safety Messaging)); or another suitable messaging system and other external conditions that could impact the safe operation of a vehicle.

Each of a plurality of vehicle applications may be assigned different safety-related priorities based on various vehicle conditions. For example, as driving speed increases, sensor polling rates, data analysis, safety decisions by the processor, information display adjustments, and the like may need to be performed or refreshed more frequently to maintain a threshold level of safety performance. As another example, if the vehicle is traveling along a long straightaway or in light traffic conditions, a polling rate of lane detection sensors and/or vehicle proximity sensors may be reduced with minimal impact on driving safety. As another example, under similar conditions, the computing resources devoted to navigation sensing, rendering, and/or display may be reduced with little impact on driving safety. As another example, under almost all conditions, substantially reducing computing resources allocated to cluster rendering and display may cause a precipitous decline in the safety-related functionality of such critical information displays.

In various embodiments, the processor may determine for each of the plurality of vehicle applications a “driver-performance-safety factor” or “driving safety quotient” that reflects a predicted relative impact on a safety-related driving task of reducing computing resources to a given vehicle application. In some embodiments, the driver-performance-safety factor may be used to determine the allocation of computing resources to a corresponding application. In some embodiments, the driver-performance-safety factor may reflect a nonlinear relationship between driver performance of one or more safety-related tasks and the allocation of computing resources to the application. In some embodiments, the driver-performance-safety factor may be determined by empirically testing the utility of each vehicle application to human performance of a safety-related driving task at different levels of computing resource allocation. In some embodiments, driver-performance-safety factors may be determined by assessing for a plurality of drivers the relative impact on driver performance of one or more safety-related driving tasks when the application is allocated a plurality of different levels of reduced computing resources, and determining one of an average or worst-case impact for each of the plurality of different levels of reduced computing resources. In some embodiments, the determined driver-performance-safety factor for each of the plurality of vehicle applications may be stored in a data structure, such as a database that can be accessed by the vehicle processor. In some embodiments, the vehicle may use a formula for estimating the relative impact of reducing computing resources to a given vehicle application on human performance of the safety-related driving task.

In some embodiments, the formula may encompass relative impacts on human performance of the safety-related driving task at a plurality of different levels of reduced computing resources determined based on testing of a plurality of drivers. For example, the formula may be represented as Xᵢ=functionᵢ (Pᵢ, Cᵢ), in which for each application i, Xᵢ represents a driver-performance-safety factor that may be impacted by varying the performance of the application, “functionᵢ” represents a formula that estimates driving safety impacts of varying the performance of the application, Pᵢ represents a performance-delivery rate in percentage (%) (e.g., actual performance relative to requested performance expressed as a percentage) of the application, and Cᵢ represents a criticality or priority of the application. In some embodiments, the function to estimate driving safety of the application may be represented as Xᵢ=Pᵢ^{(Ci)}. In some embodiments, an overall driver performance safety factor X may be represented as X=min(Xᵢ for all i). The overall driver performance safety factor X may be expressed as a minimum value of all driver performance safety factors because the human or user perception or safety may be determined by the worst portion of the system. The overall driver performance safety factor may be determined based on or as a minimum value of all driver performance safety factors. Further, allocating computing resource in various embodiments may be determined based on the overall driver performance safety factor, and not based on all or each of the driver performance safety factors.

In some embodiments, in response to a need to limit computing resources to remain within some performance parameter (e.g., maximum temperature, peak current, processor resource limits, etc.), the processor may determine a utilization of total computing resources, and may allocate computing resources to each of the plurality of vehicle applications so as to maintain a certain minimum driver safety quotient (i.e., overall impact on driver safety performance) based on determined the driver-performance-safety factor of each vehicle application, and the determined utilization of total computing resources.

As a non-limiting example, the processor may determine whether a temperature of the processor meets or exceeds a maximum operating temperature threshold, and determined that total computing resources need to be reduced in response to determining that the temperature of the processor exceeds the maximum temperature threshold. Temperature parameters that could trigger reducing computing resources may include temperatures due to heat generated from the processor, ambient heat generated by other components, and/or external climate/weather temperatures. In response to determining that computing resources need to be reduced, the processor may reduce the target for the overall driver safety quotient, and allocate computing resources to each of the plurality of vehicle applications based on the determined driver-performance-safety factor of each vehicle application to achieve or maintain the adjusted driver safety quotient, thereby reducing the total computing resources. If the maximum operating temperature threshold is still exceeded, the processor may repeat the process of reducing the target for the overall driver safety quotient, and allocating computing resources to each of the plurality of vehicle applications based on the driver-performance-safety factor of each vehicle application to achieve or maintain the further reduced driver safety quotient until the operating temperature falls below the maximum threshold.

Another example of a constraint that could trigger reducing computing resources is peak current, which could exceed a maximum threshold due to momentary instantaneous peak current, such as due to a burst in workload. Exceeding a peak current threshold may damage the main power supply or cause shutdown due to over current protections. So, in response to detecting a peak current exceeding a constraint or threshold, the processor may reduce the target for the overall driver safety quotient, and allocate computing resources to each of the plurality of vehicle applications based on the driver-performance-safety factor of each vehicle application to achieve or maintain the reduced driver safety quotient, thereby reducing the total computing resources.

Another example of a constraint that could trigger reducing computing resources may occur when the processor is resource limited. For example, in response to determining that too many vehicle applications have started running concurrently that can be allocated processor resources, the processor may reduce the target for the overall driver safety quotient, and allocate computing resources to each of the plurality of vehicle applications based on the determined driver-performance-safety factor of each vehicle application to achieve or maintain the reduced driver safety quotient, thereby reducing the total computing resources.

Various embodiments improve the functionality of vehicle systems by providing at least some computing resources to a plurality of vehicle applications that are important to the safe operation of the vehicle even when overall computing resources are reduced. Various embodiments improve the safety of vehicles by allocating finite computing resources to the plurality of vehicle applications according to the importance of the vehicle application to safe vehicle operations or impact on a driver's ability to perform one or more safety-related tasks in a particular situation or context.

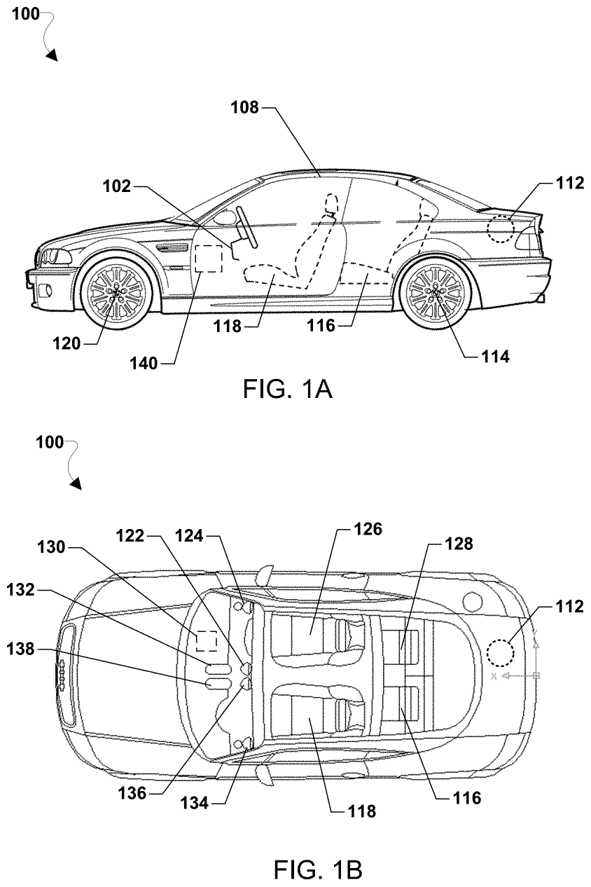

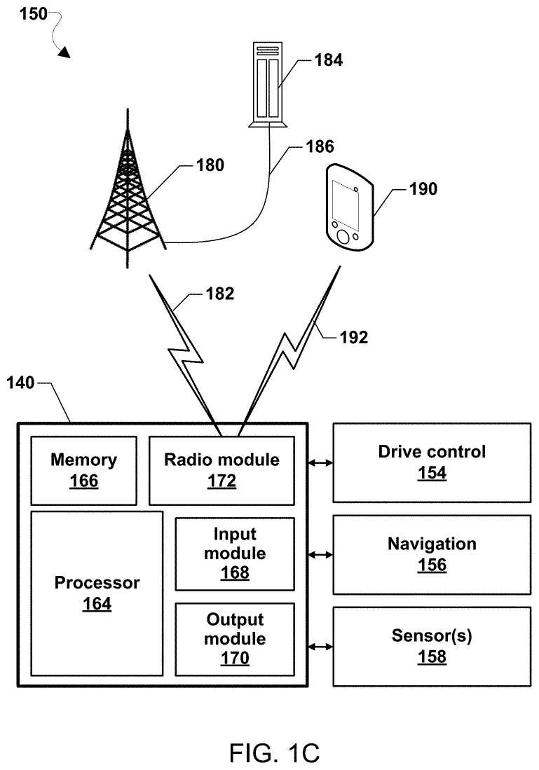

Various embodiments may be implemented within a variety of vehicles, an example vehicle 100 of which is illustrated in FIGS. 1A and 1B. With reference to FIGS. 1A and 1B, a vehicle 100 may include a control unit 140 and a plurality of sensors 102-138, including satellite geopositioning system receivers 108, occupancy sensors 112, 116, 118, 126, 128, tire pressure sensors 114, 120, cameras 122, 136, microphones 124, 134, impact sensors 130, radar 132, and lidar 138. The plurality of sensors 102-138, disposed in or on the vehicle, may be used for various purposes, such as autonomous and semi-autonomous navigation and control, crash avoidance, position determination, etc., as well to provide sensor data regarding objects and people in or on the vehicle 100. The sensors 102-138 may include one or more of a wide variety of sensors capable of detecting a variety of information useful for navigation and collision avoidance. Each of the sensors 102-138 may be in wired or wireless communication with a control unit 140, as well as with each other. In particular, the sensors may include one or more cameras 122, 136 or other optical sensors or photo optic sensors. The sensors may further include other types of object detection and ranging sensors, such as radar 132, lidar 138, IR sensors, and ultrasonic sensors. The sensors may further include tire pressure sensors 114, 120, humidity sensors, temperature sensors, satellite geopositioning sensors 108, accelerometers, vibration sensors, gyroscopes, gravimeters, impact sensors 130, force meters, stress meters, strain sensors, fluid sensors, chemical sensors, gas content analyzers, pH sensors, radiation sensors, Geiger counters, neutron detectors, biological material sensors, microphones 124, 134, occupancy sensors 112, 116, 118, 126, 128, proximity sensors, and other sensors.

The vehicle control unit 140 may be configured with processor-executable instructions to perform various embodiments using information received from various sensors, particularly the cameras 122, 136. In some embodiments, the control unit 140 may supplement the processing of camera images using distance and relative position (e.g., relative bearing angle) that may be obtained from radar 132 and/or lidar 138 sensors. The control unit 140 may further be configured to control steering, breaking and speed of the vehicle 100 when operating in an autonomous or semi-autonomous mode using information regarding other vehicles determined using various embodiments.

FIG. 1C is a component block diagram illustrating a system 150 of components and support systems suitable for implementing various embodiments. With reference to FIGS. 1A, 1B, and 1C, a vehicle 100 may include a control unit 140, which may include various circuits and devices used to control the operation of the vehicle 100. In the example illustrated in FIG. 1C, the control unit 140 includes a processor 164, memory 166, an input module 168, an output module 170 and a radio module 172. The control unit 140 may be coupled to and configured to control drive control components 154, navigation components 156, and one or more sensors 158 of the vehicle 100.

The control unit 140 may include a processor 164 that may be configured with processor-executable instructions to control maneuvering, navigation, and/or other operations of the vehicle 100, including operations of various embodiments. The processor 164 may be coupled to the memory 166. The control unit 162 may include the input module 168, the output module 170, and the radio module 172.

The radio module 172 may be configured for wireless communication. The radio module 172 may exchange signals 182 (e.g., command signals for controlling maneuvering, signals from navigation facilities, etc.) with a network transceiver 180, and may provide the signals 182 to the processor 164 and/or the navigation unit 156. In some embodiments, the radio module 172 may enable the vehicle 100 to communicate with a wireless communication device 190 through a wireless communication link 192. The wireless communication link 192 may be a bidirectional or unidirectional communication link, and may use one or more communication protocols.

The input module 168 may receive sensor data from one or more vehicle sensors 158 as well as electronic signals from other components, including the drive control components 154 and the navigation components 156. The output module 170 may be used to communicate with or activate various components of the vehicle 100, including the drive control components 154, the navigation components 156, and the sensor(s) 158.

The control unit 140 may be coupled to the drive control components 154 to control physical elements of the vehicle 100 related to maneuvering and navigation of the vehicle, such as the engine, motors, throttles, steering elements, flight control elements, braking or deceleration elements, and the like. The drive control components 154 may also include components that control other devices of the vehicle, including environmental controls (e.g., air conditioning and heating), external and/or interior lighting, interior and/or exterior informational displays (which may include a display screen or other devices to display information), safety devices (e.g., haptic devices, audible alarms, etc.), and other similar devices.

The control unit 140 may be coupled to the navigation components 156, and may receive data from the navigation components 156 and be configured to use such data to determine the present position and orientation of the vehicle 100, as well as an appropriate course toward a destination. In various embodiments, the navigation components 156 may include or be coupled to a global navigation satellite system (GNSS) receiver system (e.g., one or more Global Positioning System (GPS) receivers) enabling the vehicle 100 to determine its current position using GNSS signals. Alternatively, or in addition, the navigation components 156 may include radio navigation receivers for receiving navigation beacons or other signals from radio nodes, such as Wi-Fi access points, cellular network sites, radio station, remote computing devices, other vehicles, etc. Through control of the drive control elements 154, the processor 164 may control the vehicle 100 to navigate and maneuver. The processor 164 and/or the navigation components 156 may be configured to communicate with a server 184 on a network 186 (e.g., the Internet) using a wireless connection 182 with a cellular data network 180 to receive commands to control maneuvering, receive data useful in navigation, provide real-time position reports, and assess other data.

The control unit 162 may be coupled to one or more sensors 158. The sensor(s) 158 may include the sensors 102-138 as described, and may the configured to provide a variety of data to the processor 164.

While the control unit 140 is described as including separate components, in some embodiments some or all of the components (e.g., the processor 164, the memory 166, the input module 168, the output module 170, and the radio module 172) may be integrated in a single device or module, such as a system-on-chip (SOC) processing device. Such an SOC processing device may be configured for use in vehicles and be configured, such as with processor-executable instructions executing in the processor 164, to perform operations of various embodiments when installed into a vehicle.

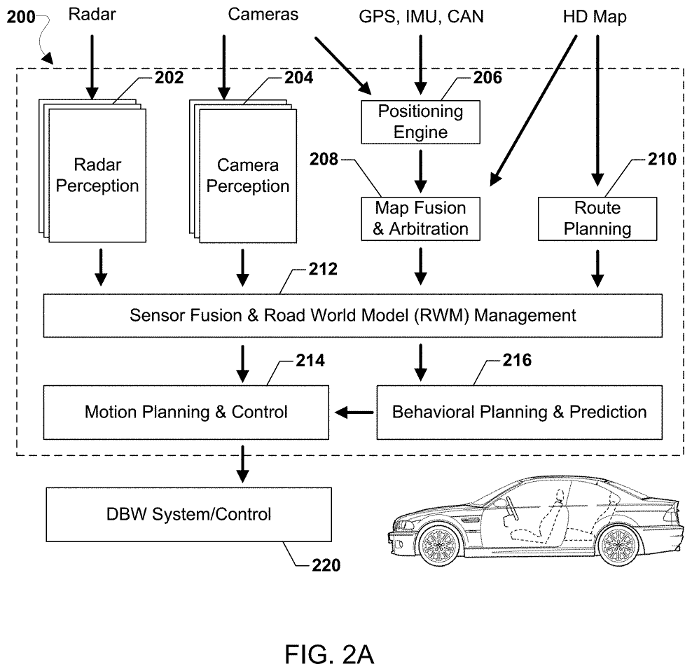

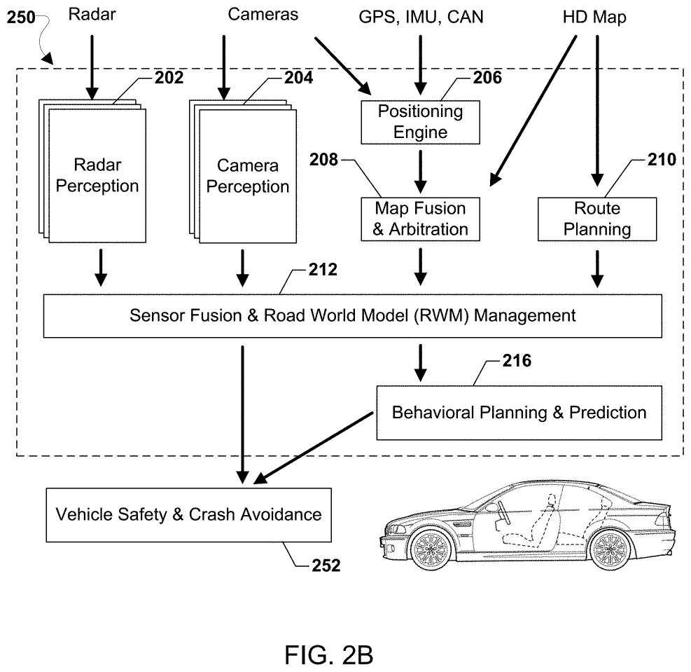

FIG. 2A illustrates an example of vehicle applications, subsystems, computational elements, or units within a vehicle management system 200, which may be utilized within a vehicle 100. With reference to FIGS. 1A-2A, in some embodiments, the various vehicle applications, computational elements, or units within vehicle management system 200 may be implemented within a system of interconnected computing devices (i.e., subsystems), that communicate data and commands to each other (e.g., indicated by the arrows in FIG. 2A). In other embodiments, the vehicle management system 200 may be implemented as a plurality of vehicle applications executing within a single computing device, such as separate threads, processes, algorithms or computational elements. However, the use of the term vehicle applications in describing various embodiments are not intended to imply or require that the corresponding functionality is implemented within a single autonomous (or semi-autonomous) vehicle management system computing device, although that is a potential implementation embodiment. Rather the use of the term vehicle applications is intended to encompass subsystems with independent processors, computational elements (e.g., threads, algorithms, subroutines, etc.) running in one or more computing devices, and combinations of subsystems and computational elements.

In various embodiments, the vehicle applications executing in a vehicle management system stack 200 may include (but is not limited to) a radar perception application 202, a camera perception application 204, a positioning engine application 206, a map fusion and arbitration application 208, a route planning application 210, sensor fusion and road world model (RWM) management application 212, motion planning and control application 214, and behavioral planning and prediction application 216. The vehicle applications 202-216 are merely examples of some vehicle applications in one example configuration of the vehicle management system stack 200. In other configurations consistent with various embodiments, other vehicle applications may be included, such as additional vehicle applications for other perception sensors (e.g., LIDAR perception layer, etc.), additional vehicle applications for planning and/or control, additional vehicle applications for modeling, etc., and/or certain of the vehicle applications 202-216 may be excluded from the vehicle management system stack 200. Each of the vehicle applications 202-216 may exchange data, computational results and commands as illustrated by the arrows in FIG. 2A.

The vehicle management system stack 200 may receive and process data from sensors (e.g., radar, lidar, cameras, inertial measurement units (IMU) etc.), navigation systems (e.g., GPS receivers, IMUs, etc.), vehicle networks (e.g., Controller Area Network (CAN) bus), and databases in memory (e.g., digital map data). The vehicle management system stack 200 may output vehicle control commands or signals to the drive by wire (DBW) system/control unit 220, which is a system, subsystem or computing device that interfaces directly with vehicle steering, throttle and brake controls. The configuration of the vehicle management system stack 200 and DBW system/control unit 220 illustrated in FIG. 2A is merely an example configuration and other configurations of a vehicle management system and other vehicle components may be used in the various embodiments. As an example, the configuration of the vehicle management system stack 200 and DBW system/control unit 220 illustrated in FIG. 2A may be used in a vehicle configured for autonomous or semi-autonomous operation while a different configuration may be used in a non-autonomous vehicle.

The radar perception vehicle application 202 may receive data from one or more detection and ranging sensors, such as radar (e.g., 132) and/or lidar (e.g., 138), and process the data to recognize and determine locations of other vehicles and objects within a vicinity of the vehicle 100. The radar perception vehicle application 202 may include use of neural network processing and artificial intelligence methods to recognize objects and vehicles, and pass such information on to the sensor fusion and RWM management vehicle application 212.

The camera perception vehicle application 204 may receive data from one or more cameras, such as cameras (e.g., 122, 136), and process the data to recognize and determine locations of other vehicles and objects within a vicinity of the vehicle 100. The camera perception vehicle application 204 may include use of neural network processing and artificial intelligence methods to recognize objects and vehicles, and pass such information on to the sensor fusion and RWM management vehicle application 212.

The positioning engine vehicle application 206 may receive data from various sensors and process the data to determine a position of the vehicle 100. The various sensors may include, but is not limited to, GPS sensor, an IMU, and/or other sensors connected via a CAN bus. The positioning engine vehicle application 206 may also utilize inputs from one or more cameras, such as cameras (e.g., 122, 136) and/or any other available sensor, such as radars, LIDARs, etc.

The map fusion and arbitration vehicle application 208 may access data within a high-definition (HD) map database and receive output received from the positioning engine vehicle application 206 and process the data to further determine the position of the vehicle 100 within the map, such as location within a lane of traffic, position within a street map, etc. The HD map database may be stored in a memory (e.g., memory 166). For example, the map fusion and arbitration vehicle application 208 may convert latitude and longitude information from GPS into locations within a surface map of roads contained in the HD map database. GPS position fixes include errors, so the map fusion and arbitration vehicle application 208 may function to determine a best guess location of the vehicle 100 within a roadway based upon an arbitration between the GPS coordinates and the HD map data. For example, while GPS coordinates may place the vehicle 100 near the middle of a two-lane road in the HD map, the map fusion and arbitration vehicle application 208 may determine from the direction of travel that the vehicle 100 is most likely aligned with the travel lane consistent with the direction of travel. The map fusion and arbitration vehicle application 208 may pass map-based location information to the sensor fusion and RWM management vehicle application 212.

The route planning vehicle application 210 may utilize the HD map, as well as inputs from an operator or dispatcher to plan a route to be followed by the vehicle 100 to a particular destination. The route planning vehicle application 210 may pass map-based location information to the sensor fusion and RWM management vehicle application 212. However, the use of a prior map by other vehicle applications, such as the sensor fusion and RWM management vehicle application 212, etc., is not required. For example, other stacks may operate and/or control the vehicle based on perceptual data alone without a provided map, constructing lanes, boundaries, and the notion of a local map as perceptual data is received.

The sensor fusion and RWM management vehicle application 212 may receive data and outputs produced by one or more of the radar perception vehicle application 202, camera perception vehicle application 204, map fusion and arbitration vehicle application 208, and route planning vehicle application 210, and use some or all of such inputs to estimate or refine the location and state of the vehicle 100 in relation to the road, other vehicles on the road, and other objects within a vicinity of the vehicle 100. For example, the sensor fusion and RWM management vehicle application 212 may combine imagery data from the camera perception vehicle application 204 with arbitrated map location information from the map fusion and arbitration vehicle application 208 to refine the determined position of the vehicle within a lane of traffic. As another example, the sensor fusion and RWM management vehicle application 212 may combine object recognition and imagery data from the camera perception vehicle application 204 with object detection and ranging data from the radar perception vehicle application 202 to determine and refine the relative position of other vehicles and objects in the vicinity of the vehicle. As another example, the sensor fusion and RWM management vehicle application 212 may receive information from vehicle-to-vehicle (V2V) communications (such as via the CAN bus) regarding other vehicle positions and directions of travel, and combine that information with information from the radar perception vehicle application 202 and the camera perception vehicle application 204 to refine the locations and motions of other vehicles. The sensor fusion and RWM management vehicle application 212 may output refined location and state information of the vehicle 100, as well as refined location and state information of other vehicles and objects in the vicinity of the vehicle, to the motion planning and control vehicle application 214 and/or the behavior planning and prediction vehicle application 216.

As a further example, the sensor fusion and RWM management vehicle application 212 may use dynamic traffic control instructions directing the vehicle 100 to change speed, lane, direction of travel, or other navigational element(s), and combine that information with other received information to determine refined location and state information. The sensor fusion and RWM management vehicle application 212 may output the refined location and state information of the vehicle 100, as well as refined location and state information of other vehicles and objects in the vicinity of the vehicle 100, to the motion planning and control vehicle application 214, the behavior planning and prediction vehicle application 216 and/or devices remote from the vehicle 100, such as a data server, other vehicles, etc., via wireless communications, such as through C-V2X connections, other wireless connections, etc.

As a still further example, the sensor fusion and RWM management vehicle application 212 may monitor perception data from various sensors, such as perception data from a radar perception vehicle application 202, camera perception vehicle application 204, other perception vehicle application, etc., and/or data from one or more sensors themselves to analyze conditions in the vehicle sensor data. The sensor fusion and RWM management vehicle application 212 may be configured to detect conditions in the sensor data, such as sensor measurements being at, above, or below a threshold, certain types of sensor measurements occurring, etc., and may output the sensor data as part of the refined location and state information of the vehicle 100 provided to the behavior planning and prediction vehicle application 216 and/or devices remote from the vehicle 100, such as a data server, other vehicles, etc., via wireless communications, such as through C-V2X connections, other wireless connections, etc.

The refined location and state information may include vehicle descriptors associated with the vehicle 100 and the vehicle owner and/or operator, such as: vehicle specifications (e.g., size, weight, color, on board sensor types, etc.); vehicle position, speed, acceleration, direction of travel, attitude, orientation, destination, fuel/power level(s), and other state information; vehicle emergency status (e.g., is the vehicle an emergency vehicle or private individual in an emergency); vehicle restrictions (e.g., heavy/wide load, turning restrictions, high occupancy vehicle (HOV) authorization, etc.); capabilities (e.g., all-wheel drive, four-wheel drive, snow tires, chains, connection types supported, on board sensor operating statuses, on board sensor resolution levels, etc.) of the vehicle; equipment problems (e.g., low tire pressure, weak breaks, sensor outages, etc.); owner/operator travel preferences (e.g., preferred lane, roads, routes, and/or destinations, preference to avoid tolls or highways, preference for the fastest route, etc.); permissions to provide sensor data to a data agency server (e.g., 184); and/or owner/operator identification information.

The behavioral planning and prediction vehicle application 216 of the autonomous vehicle system stack vehicle application 200 may use the refined location and state information of the vehicle 100 and location and state information of other vehicles and objects output from the sensor fusion and RWM management vehicle application 212 to predict future behaviors of other vehicles and/or objects. For example, the behavioral planning and prediction vehicle application 216 may use such information to predict future relative positions of other vehicles in the vicinity of the vehicle based on own vehicle position and velocity and other vehicle positions and velocity. Such predictions may take into account information from the HD map and route planning to anticipate changes in relative vehicle positions as host and other vehicles follow the roadway. The behavioral planning and prediction vehicle application 216 may output other vehicle and object behavior and location predictions to the motion planning and control vehicle application 214.

Additionally, the behavior planning and prediction vehicle application 216 may use object behavior in combination with location predictions to plan and generate control signals for controlling the motion of the vehicle 100. For example, based on route planning information, refined location in the roadway information, and relative locations and motions of other vehicles, the behavior planning and prediction vehicle application 216 may determine that the vehicle 100 needs to change lanes and accelerate, such as to maintain or achieve minimum spacing from other vehicles, and/or prepare for a turn or exit. As a result, the behavior planning and prediction vehicle application 216 may calculate or otherwise determine a steering angle for the wheels and a change to the throttle setting to be commanded to the motion planning and control vehicle application 214 and DBW system/control vehicle applications 220 along with such various parameters necessary to effectuate such a lane change and acceleration. One such parameter may be a computed steering wheel command angle.

The motion planning and control vehicle application 214 may receive data and information outputs from the sensor fusion and RWM management vehicle application 212 and other vehicle and object behavior as well as location predictions from the behavior planning and prediction vehicle application 216, and use this information to plan and generate control signals for controlling the motion of the vehicle 100 and to verify that such control signals meet safety requirements for the vehicle 100. For example, based on route planning information, refined location in the roadway information, and relative locations and motions of other vehicles, the motion planning and control vehicle application 214 may verify and pass various control commands or instructions to the DBW system/control vehicle applications 220.

The DBW system/control unit 220 may receive the commands or instructions from the motion planning and control vehicle application 214 and translate such information into mechanical control signals for controlling wheel angle, brake and throttle of the vehicle 100. For example, DBW system/control vehicle applications 220 may respond to the computed steering wheel command angle by sending corresponding control signals to the steering wheel controller.

In various embodiments, the vehicle management system stack 200 may include functionality that performs safety checks or oversight of various commands, planning or other decisions of various vehicle applications that could impact vehicle and occupant safety. Such safety check or oversight functionality may be implemented within a dedicated vehicle application or distributed among various vehicle applications and included as part of the functionality. In some embodiments, a variety of safety parameters may be stored in memory and the safety checks or oversight functionality may compare a determined value (e.g., relative spacing to a nearby vehicle, distance from the roadway centerline, etc.) to corresponding safety parameter(s), and issue a warning or command if the safety parameter is or will be violated. For example, a safety or oversight function in the behavior planning and prediction vehicle application 216 (or in a separate vehicle application) may determine the current or future separate distance between another vehicle (as refined by the sensor fusion and RWM management vehicle application 212) and the vehicle 100 (e.g., based on the world model refined by the sensor fusion and RWM management vehicle application 212), compare that separation distance to a safe separation distance parameter stored in memory, and issue instructions to the motion planning and control vehicle application 214 to speed up, slow down or turn if the current or predicted separation distance violates the safe separation distance parameter. As another example, safety or oversight functionality in the motion planning and control vehicle application 214 (or a separate vehicle application) may compare a determined or commanded steering wheel command angle to a safe wheel angle limit or parameter, and issue an override command and/or alarm in response to the commanded angle exceeding the safe wheel angle limit.

Some safety parameters stored in memory may be static (i.e., unchanging over time), such as maximum vehicle speed. Other safety parameters stored in memory may be dynamic in that the parameters are determined or updated continuously or periodically based on vehicle state information and/or environmental conditions. Non-limiting examples of safety parameters include maximum safe speed, maximum brake pressure, maximum acceleration, and the safe wheel angle limit, all of which may be a function of roadway and weather conditions.

FIG. 2B illustrates an example of vehicle applications, subsystems, computational elements, or units within a vehicle management system 250, which may be utilized within a vehicle 100. With reference to FIGS. 1A-2B, in some embodiments, the vehicle applications 202, 204, 206, 208, 210, 212, and 216 of the vehicle management system stack 200 may be similar to those described with reference to FIG. 2A and the vehicle management system stack 250 may operate similar to the vehicle management system stack 200, except that the vehicle management system stack 250 may pass various data or instructions to a vehicle safety and crash avoidance system 252 rather than the DBW system/control vehicle application 220. For example, the configuration of the vehicle management system stack 250 and the vehicle safety and crash avoidance system vehicle application 252 illustrated in FIG. 2B may be used in a non-autonomous vehicle.

In various embodiments, the behavioral planning and prediction vehicle application 216 and/or sensor fusion and RWM management vehicle application 212 may output data to the vehicle safety and crash avoidance system vehicle application 252. For example, the sensor fusion and RWM management vehicle application 212 may output sensor data as part of refined location and state information of the vehicle 100 provided to the vehicle safety and crash avoidance system vehicle application 252. The vehicle safety and crash avoidance system vehicle application 252 may use the refined location and state information of the vehicle 100 to make safety determinations relative to the vehicle 100 and/or occupants of the vehicle 100. As another example, the behavioral planning and prediction vehicle application 216 may output behavior models and/or predictions related to the motion of other vehicles to the vehicle safety and crash avoidance system 252. The vehicle safety and crash avoidance system vehicle application 252 may use the behavior models and/or predictions related to the motion of other vehicles to make safety determinations relative to the vehicle 100 and/or occupants of the vehicle 100.

In various embodiments, the vehicle safety and crash avoidance system vehicle application 252 may include functionality that performs safety checks or oversight of various commands, planning, or other decisions of various vehicle applications, as well as human driver actions, that could impact vehicle and occupant safety. In some embodiments, a variety of safety parameters may be stored in memory and the vehicle safety and crash avoidance system vehicle application 252 may compare a determined value (e.g., relative spacing to a nearby vehicle, distance from the roadway centerline, etc.) to corresponding safety parameter(s), and issue a warning or command if the safety parameter is or will be violated. For example, a vehicle safety and crash avoidance system vehicle application 252 may determine the current or future separate distance between another vehicle (as refined by the sensor fusion and RWM management vehicle application 212) and the vehicle (e.g., based on the world model refined by the sensor fusion and RWM management vehicle application 212), compare that separation distance to a safe separation distance parameter stored in memory, and issue instructions to a driver to speed up, slow down or turn if the current or predicted separation distance violates the safe separation distance parameter. As another example, a vehicle safety and crash avoidance system vehicle application 252 may compare a human driver's change in steering wheel angle to a safe wheel angle limit or parameter, and issue an override command and/or alarm in response to the steering wheel angle exceeding the safe wheel angle limit.

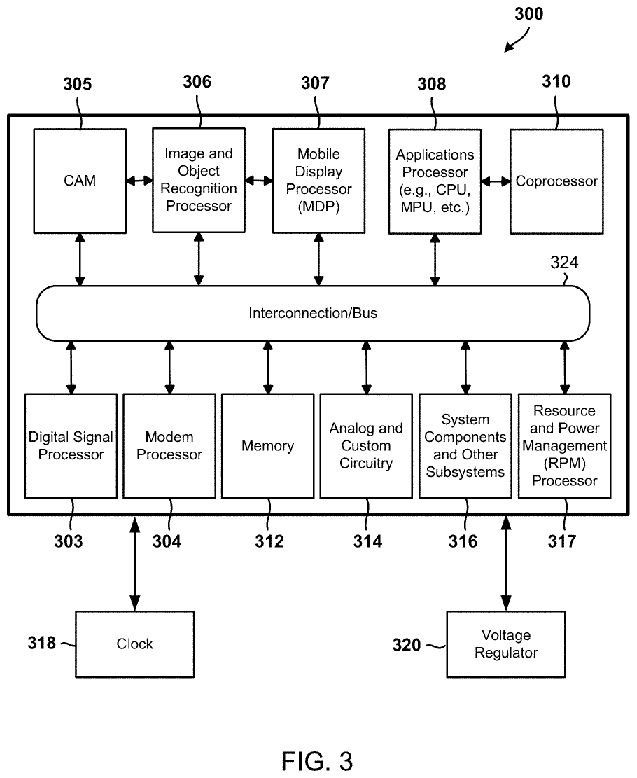

FIG. 3 illustrates an example system-on-chip (SOC) architecture of a processing device SOC 300 suitable for implementing various embodiments in vehicles. With reference to FIGS. 1A-3, the processing device SOC 300 may include a variety of processing resources, including a number of heterogeneous processors, such as a digital signal processor (DSP) 303, a modem processor 304, an image and object recognition processor 306, a mobile display processor 307, an applications processor 308, and a resource and power management (RPM) processor 317. The processing device SOC 300 may also include one or more coprocessors 310 (e.g., vector co-processor) connected to one or more of the heterogeneous processors 303, 304, 306, 307, 308, 317. Each of the processors may include one or more cores, and an independent/internal clock. Each processor/core may perform operations independent of the other processors/cores. For example, the processing device SOC 300 may include a processor that executes a first type of operating system (e.g., FreeBSD, LINUX, OS X, etc.) and a processor that executes a second type of operating system (e.g., Microsoft Windows). In some embodiments, the applications processor 308 may be the SOC's 300 main processor, central processing unit (CPU), microprocessor unit (MPU), arithmetic logic unit (ALU), etc. The graphics processor 306 may be graphics processing unit (GPU).

The processing device SOC 300 may include analog circuitry and custom circuitry 314 for managing sensor data, analog-to-digital conversions, wireless data transmissions, and for performing other specialized operations, such as processing encoded audio and video signals for rendering in a web browser. The processing device SOC 300 may further include system components and other subsystems 316, such as voltage regulators, oscillators, phase-locked loops, peripheral bridges, data controllers, memory controllers, system controllers, access ports, timers, and other similar components used to support the processors and software clients (e.g., a web browser) running on a computing device.

The processing device SOC 300 also include specialized circuitry for camera actuation and management (CAM) 305 that includes, provides, controls and/or manages the operations of one or more cameras 122, 136 (e.g., a primary camera, webcam, 3D camera, etc.), the video display data from camera firmware, image processing, video preprocessing, video front-end (VFE), in-line JPEG, high definition video codec, etc. The CAM 305 may be an independent processing unit and/or include an independent or internal clock.

In some embodiments, the image and object recognition processor 306 may be configured with processor-executable instructions and/or specialized hardware configured to perform image processing and object recognition analyses involved in various embodiments. For example, the image and object recognition processor 306 may be configured to perform the operations of processing images received from cameras (e.g., 122, 136) via the CAM 305 to recognize and/or identify other vehicles, and otherwise perform functions of the camera perception vehicle application 204 as described. In some embodiments, the processor 306 may be configured to process radar or lidar data and perform functions of the radar perception vehicle application 202 as described.

The system components and other subsystems 316, analog and custom circuitry 314, and/or CAM 305 may include circuitry to interface with peripheral devices, such as cameras 122, 136, radar 132, lidar 138, electronic displays, wireless communication devices, external memory chips, etc. The processors 303, 304, 306, 307, 308 may be interconnected to one or more memory elements 312, system components and other subsystems 316, analog and custom circuitry 314, CAM 305, and RPM processor 317 via an interconnection/bus module 324, which may include an array of reconfigurable logic gates and/or implement a bus architecture (e.g., CoreConnect, AMBA, etc.). Communications may be provided by advanced interconnects, such as high-performance networks-on chip (NoCs).

The processing device SOC 300 may further include an input/output module (not illustrated) for communicating with resources external to the SOC, such as a clock 318 and a voltage regulator 320. Resources external to the SOC (e.g., clock 318, voltage regulator 320) may be shared by two or more of the internal SOC processors/cores (e.g., a DSP 303, a modem processor 304, a graphics processor 306, an applications processor 308, etc.).

In some embodiments, the processing device SOC 300 may be included in a control unit (e.g., 140) for use in a vehicle (e.g., 100). The control unit may include communication links for communication with a telephone network (e.g., 180), the Internet, and/or a network server (e.g., 184) as described.

The processing device SOC 300 may also include additional hardware and/or software components that are suitable for collecting sensor data from sensors, including motion sensors (e.g., accelerometers and gyroscopes of an IMU), user interface elements (e.g., input buttons, touch screen display, etc.), microphone arrays, sensors for monitoring physical conditions (e.g., location, direction, motion, orientation, vibration, pressure, etc.), cameras, compasses, GPS receivers, communications circuitry (e.g., Bluetooth®, WLAN, WiFi, etc.), and other well-known components of modern electronic devices.

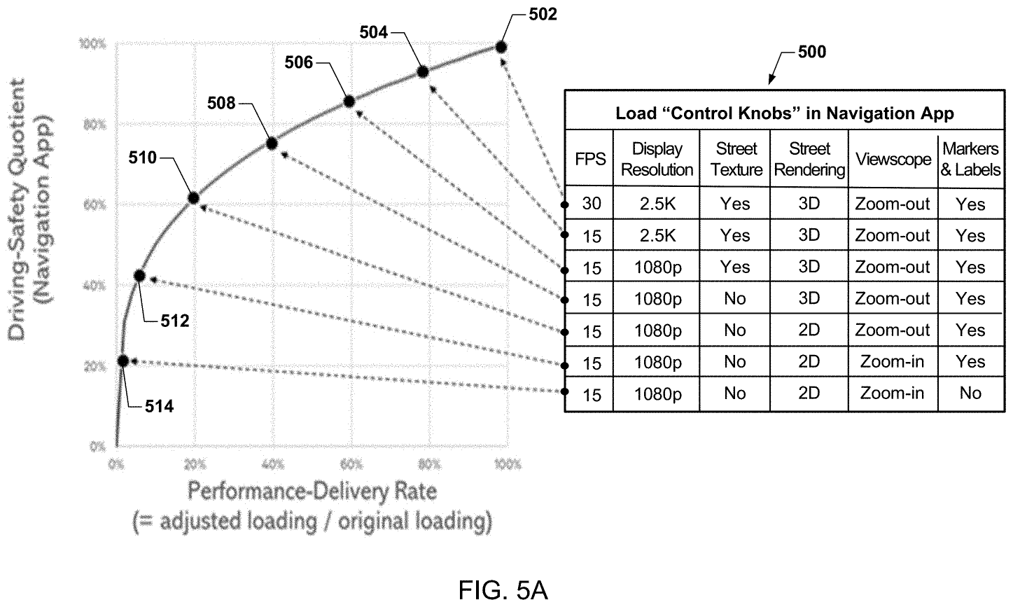

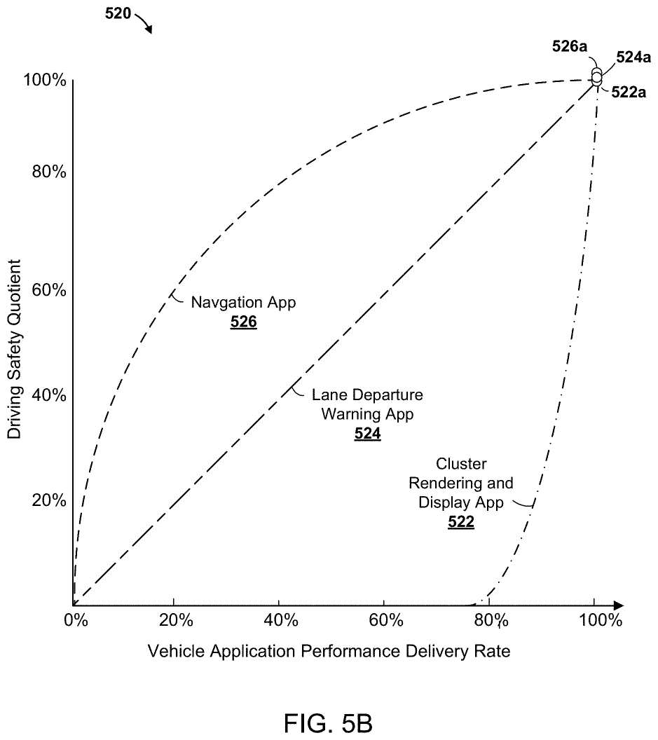

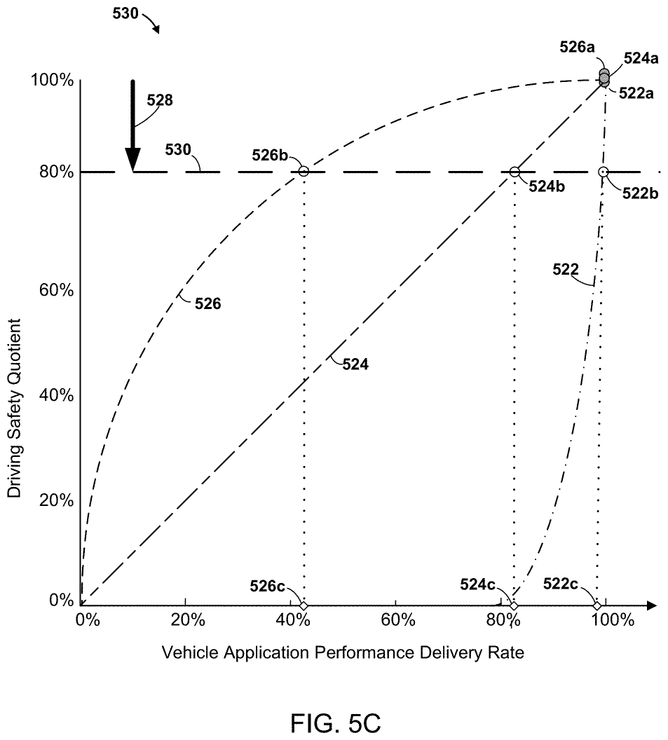

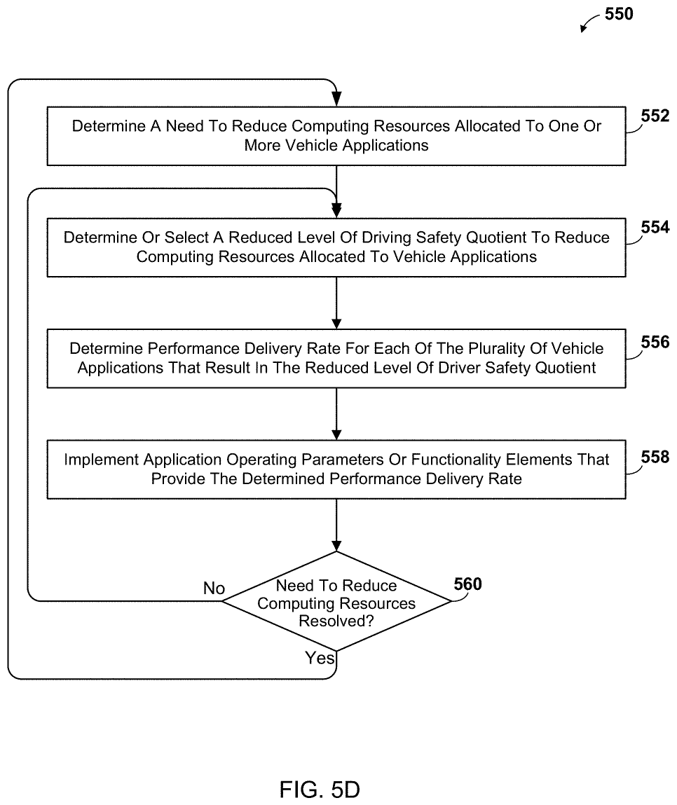

Some or all of the elements within the SOC 300 described with reference to FIG. 3 may be computing resources that are allocated to vehicle applications according to various embodiments. However, allocable computing resources also include voltages (or currents) supplied to the SOC 300 and/or particular components within therein, such as by the voltage regulator 320, and/or operating frequency allocated to the SOC 300 and/or particular components within therein, such as by the clock 318. For example, the purpose of allocating computing resources may involve reducing (or increasing): the rate of processing operations (e.g., number of operations performed per second); memory usage; processor operating frequency; processor current, access to co-processors or other components, etc., which are generally and collectively referred to herein as computing resources. Further, reductions in allocated computing resources (e.g., processing operations, memory usage, processor frequency, processor current, etc.) may be achieved by various vehicle applications by adjusting one or more parameters or alternatives affecting application performance or operations as described herein with reference to FIG. 5A. For example, allocate computing resources to each vehicle application may be accomplished by adjusting one or more of display frames per second, display resolution, processing accuracy or resolution, quality of output, algorithms used by the application, or functionality of the application.

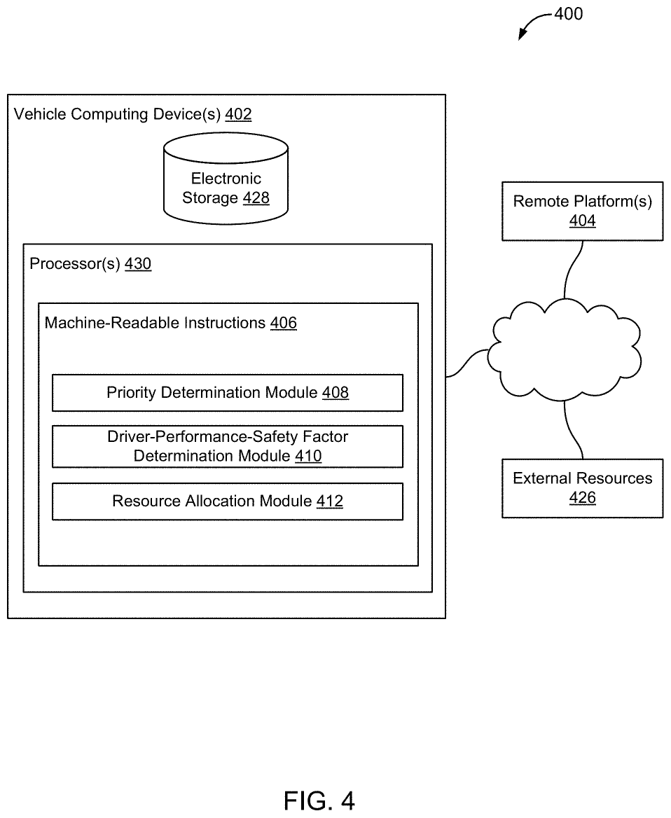

FIG. 4 is a component block diagram illustrating a system 400 configured for allocating computing resources to an application performed by a processor of a vehicle in accordance with various embodiments. In some embodiments, the system 400 may include one or more vehicle computing devices 402 and/or one or more remote platforms 404. With reference to FIGS. 1A-4, the vehicle computing device(s) 402 may include one or more processors 430, such as processor 164, a processing device 300, and/or a control unit 140 (variously referred to as a “processor” 430) of a vehicle (e.g., 100). The remote platform(s) 404 may include a processor (e.g., 164), a processing device (e.g., 300), and/or a control unit (e.g., 140) (variously referred to as a “processor”) of a vehicle (e.g., 100).

The vehicle computing device(s) 402 may include one or more processors 430 configured by machine-executable instructions 406. Machine-executable instructions 406 may include one or more instruction modules. The instruction modules may include computer program modules. The instruction modules may include one or more of a priority determination module 408, a driver-performance-safety factor determination module 410, a resource allocation module 412, and/or other instruction modules.

The priority determination module 408 may be configured to determine a priority to safe vehicle operations of each of a plurality of vehicle applications based on one or more vehicle conditions. The priority determination module 408 may be configured to determine the priority of each of the plurality of vehicle applications based on one or more of an in-cabin condition and an external condition.

The driver-performance-safety factor determination module 410 may be configured to determine a driver-performance-safety factor for each of the plurality of vehicle applications. The driver-performance-safety factor determination module 410 may be configured to determine the driver-performance-safety factor for each of the plurality of vehicle applications based on the contribution to safe vehicle operations of each of the plurality of vehicle applications. The driver-performance-safety factor determination module 410 may be configured to determine a level of utility of each vehicle application to human performance of the safety-related driving task.

The driver-performance-safety factor determination module 410 may be configured to access a database of driver-performance-safety factors (e.g., stored in the electronic storage 428). In some embodiments, the database of driver-performance-safety factors may be generated by assessing for a plurality of drivers relative impacts on their driver performance of the safety-related driving task when each application is operated at a plurality of different levels of reduced computing resources, and determining one of average or worst-case impacts for each of the plurality of different levels of reduced computing resources.

The resource allocation module 412 may be configured to allocate computing resources to each of the plurality of vehicle applications based on the determined driver-performance-safety factor of each vehicle application. The resource allocation module 412 may be configured to allocate computing resources to each of the plurality of vehicle applications based on determined the performance-safety quotient of each vehicle application, and the determined utilization of total computing resources. The resource allocation module 412 may be configured to allocate computing resources to each of the plurality of vehicle applications based on determined the performance-safety quotient of each vehicle application, and the reduced total computing resources.

In some implementations, vehicle computing device(s) 402, remote platform(s) 404, and/or external resources 426 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which vehicle computing device(s) 402, remote platform(s) 404, and/or external resources 426 may be operatively linked via some other communication media.

A given remote platform 404 may include one or more processors configured to execute computer program modules. The computer program modules may be configured to enable an expert or user associated with the given remote platform 404 to interface with system 400 and/or external resources 426, and/or provide other functionality attributed herein to remote platform(s) 404. By way of non-limiting example, the given remote platform 404 may include one or more of a desktop computer, a laptop computer, a handheld computer, a tablet vehicle computing device, a NetBook, a Smartphone, a gaming console, and/or other vehicle computing devices.

External resources 426 may include sources of information outside of system 400, external entities participating with system 400, and/or other resources. In some implementations, some or all of the functionality attributed herein to external resources 426 may be provided by resources included in system 400.

Vehicle computing device(s) 402 may include electronic storage 428, one or more processors 430, and/or other components. Vehicle computing device(s) 402 may include communication lines, or ports to enable the exchange of information with a network and/or other vehicle computing devices. Illustration of vehicle computing device(s) 402 in FIG. 4 is not intended to be limiting. Vehicle computing device(s) 402 may include a plurality of hardware, software, and/or firmware components operating together to provide the functionality attributed herein to vehicle computing device(s) 402. For example, vehicle computing device(s) 402 may be implemented by a cloud of vehicle computing devices operating together as vehicle computing device(s) 402.

Electronic storage 428 may include non-transitory storage media that electronically stores information. The electronic storage media of electronic storage 428 may include one or both of system storage that is provided integrally (i.e., substantially non-removable) with vehicle computing device(s) 402 and/or removable storage that is removably connectable to vehicle computing device(s) 402 via, for example, a port (e.g., a Universal Serial Bus (USB) port, a firewire port, etc.) or a drive (e.g., a disk drive, etc.). Electronic storage 428 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 428 may include one or more virtual storage resources (e.g., cloud storage, a virtual private network, and/or other virtual storage resources). Electronic storage 428 may store software algorithms, information determined by processor(s) 430, information received from vehicle computing device(s) 402, information received from remote platform(s) 404, and/or other information that enables vehicle computing device(s) 402 to function as described herein.

Processor(s) 430 may be configured to provide information processing capabilities in vehicle computing device(s) 402. As such, the processor(s) 430 may include one or more of a digital processor, an analog processor, a digital circuit designed to process information, an analog circuit designed to process information, a state machine, and/or other mechanisms for electronically processing information. Although the processor(s) 430 is shown in FIG. 4 as a single entity, this is for illustrative purposes only. In some implementations, the processor(s) 430 may include a plurality of processing units and/or processor cores. The processing units may be physically located within the same device, or processor(s) 430 may represent processing functionality of a plurality of devices operating in coordination. The processor(s) 430 may be configured to execute modules 408, 410, 412, 414, 416, 418, 420, 422, and/or 424, and/or other modules by software; hardware; firmware; some combination of software, hardware, and/or firmware; and/or other mechanisms for configuring processing capabilities on processor(s) 430. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 408-412 are illustrated in FIG. 4 as being implemented within a single processing unit, in implementations in which the processor(s) 430 includes multiple processing units and/or processor cores, one or more of modules 408-412 may be implemented remotely from the other modules. The description of the functionality provided by the different modules 408-412 described below is for illustrative purposes, and is not intended to be limiting, as any of modules 408-412 may provide more or less functionality than is described. For example, one or more of the modules 408-412 may be eliminated, and some or all of its functionality may be provided by other modules 408-412. As another example, the processor(s) 430 may be configured to execute one or more additional modules that may perform some or all of the functionality attributed below to one of the modules 408-412.

FIG. 5A is a graph and illustration of an example of a relationship between a driving safety quotient and the performance delivery rate using a navigation application as an illustrative example, as well as an example of different performance levels and functionality that can be controlled in order to reduce or accommodate a reduction in computing resources demanded by or allocated to an application. With reference to FIGS. 1-5A, the relationships and functionality of vehicle applications performed by a processor (e.g., the processor 164, 303, 304, 306, 307, 308, 310, 317, 430) of a vehicle (e.g., the vehicle 100) at different levels of performance may be correlated to a driver safety quotient through driver testing.

Table 500 in FIG. 5A illustrates examples of various application parameters and functionality elements that may be adjusted (referred to as “load control knobs”) in order to reduce or accommodate reductions in allocated computing resources. Some nonlimiting examples of computing resources that may be adjusted include processor operating frequency, processor current, access to co-processors or other components, memory usage, the rate of processing operations, the rate at which displays are refreshed (e.g., expressed in frames per second (FPS)), display resolution, and functionality associated with the particular application. For example, the table 500 illustrates some non-limiting example of parameters and functionality elements that may be adjusted as “load control knobs” for a navigation application to achieve or accommodate reductions in allocated computing resources. Specifically, the table 500 list as “load control knobs” the refresh rate of a display in terms of frames per second (FPS), display resolution or pixel density, and application functionality elements that affects displayed object resolution or quality, including whether texturing applied to street features, display format (e.g., two-dimensional vs. three-dimensional rendering of streets), functionality of the application such as supporting or not supporting optional functionality like zoom and labeling features. In some applications, further “load control knobs” may include selecting particular algorithms used by the application, such as using approximating algorithms instead of full calculation algorithms in order to reduce processing operations and/or memory utilization.

Adjusting each of the application parameters may be used for reducing or responding to reductions in computing resources may result in different levels of application functionality or performance, referred to in the figure as “performance-delivery rate.” As illustrated in FIG. 5A, the performance-delivery rate of an application may be rated from 100% performance (i.e., when the application is provided fall access to all utilize computing resources and application functionality) to 0% performance when the application is effectively turned off.

Reducing the performance-delivery rate of a vehicle application may have an impact on the driver's performance of safety-related tasks as the vehicle application provides less support to the driver. As described herein, reductions in the performance delivery rate of each vehicle application may have a different impact on driver performance pending upon the criticality of the information provided by the vehicle application to the driver. This impact on driver safety task performance, is referred to herein as the driver safety quotient, which may be expressed in terms of percentage from 100% associated with the driver safety task performance when the vehicle application is providing 100% of its performance delivery rate to some minimum percentage when the vehicle application is effectively turned off. As explained herein, the percentage impact on driver safety task performance, or driver safety quotient, may be determined based on driver testing as explained herein.

FIG. 5A illustrates how changes in computing resources and application functionality (i.e., “load control knobs”) resulting in changes in the application performance delivery rate (plotted on the X axis) can be related to driver safety task performance or driver safety quotient (plotted on the y-axis) in the form of a performance curve. The impact of adjusting the various functional elements on the percentage of computing resources allocated to the navigation application can be linked to the determined and plotted on a X access. These values may be plotted in terms of percentages from zero percent (0%) in which the application is completely turned off to 100% in which the application is allocated fall computing power and resources to achieve 100% of its performance capability.

As explained here in, the impact on the driver safety are performance of a safety-related task can be determined by testing a number of individuals in vehicles or vehicle trainers performing a variety of safety-related tasks with the navigation application functioning at each of the levels of degraded performance. As indicated in the table. By determining a worst-case performance impact average worst-case performance impact across multiple drivers, the eight measure of performance, degradation, such as in percentage values, can be determined. These driver impact evaluations may be plotted in terms of percentage from 100% being the best performance of drivers on safety-related tasks when the application is providing its 100% performance delivery rate to whatever minimum driver safety task performance is observed when the vehicle application is essentially turned off. In which case the drivers are unable to even perform the safety-related tasks.

FIG. 5A illustrates how changing various application performance elements can result in different levels of performance delivery rates, which may lead to different levels of demand on the computing resources, such as processor operations per second, processor operating frequency, processor currents, memory demands, etc. In the illustrated example, when the navigation application is operated at full capability and functionality, providing a 100% performance delivery rate, the application provides 100% of the whatever contribution the application makes to driver safety task performance (i.e., the driver safety quotient equals 100%), as indicated as point 502 on the graph. In this example, full capability and functionality is achieved when the display refreshes at 30 FPS with a display resolution of 2.5K, the rendering of streets in the display include texturing and 3D rendering, view scope supports zoom-out functionality, and markers and labels are included on displayed objects.

A reduction in allocated computing resources, such as processor operations per second, can be achieved by reducing the display refresh rate from 30 FPS to 15 FPS. With no other changes in functionality or display quality, the this may result in a reduction in the performance delivery rate of the application to approximately 78% as indicated by point 504. As illustrated, driver testing may reveal that reducing the refresh rate to 15 FPS may result in a reduction in the driver safety quotient to approximately 92% (i.e., an ˜8% reduction in driver safety task performance.).

A reduction in allocated computing resources, such as processor operations per second, can be achieved by reducing the display refresh rate from 30 FPS to 15 FPS and reducing the display resolution to 1080p. With no other changes in functionality or display quality, the this may result in a reduction in the performance delivery rate of the application to approximately 60% as indicated by point 506. As illustrated, driver testing may reveal that operating the display at 15 FPS and 1080p resolution may result in a reduction in the driver safety quotient to approximately 85% (i.e., an ˜15% reduction in driver safety task performance.) at point 508. Further, turning of texturing of street objects in the display may result in a performance delivery rate of approximately 40% resulting in a reduction in the driver safety quotient to approximately 75% at point 510. Further, turning off 3D rendering of streets in the display may result in a performance delivery rate of approximately 20% resulting in a reduction in the driver safety quotient to approximately 60% at point 510. Further, turning off zoom-out functionality may result in a performance delivery rate of approximately 5% resulting in a reduction in the driver safety quotient to approximately 43% at point 512. Further, turning off markers and labels in the display may result in a performance delivery rate of approximately 2% resulting in a reduction in the driver safety quotient to approximately 22% at point 514.

FIG. 5A is provided as an illustrative example of how reducing or turning of different types of computing functionality elements in a vehicle application can reduce the application's performance delivery rate and affect driver safety task performance or driving safety quotient. The actual impact on the driving safety quotient of changes in a navigation application functionality differ from what is displayed in the figure. Further, the different types of computing functionality elements that can be adjusted (the “load control knobs”) will depend upon the specific vehicle application and may vary based upon the manner in which an application developer chooses to permit or provide gradual degradation in the application performance delivery rate.

FIG. 5B is a notional graph 520 of driving safety quotient as a function of application performance delivery rate which is linked to the allocation of computing resources to each vehicle application. With reference to FIGS. 1-5B, the relationships and functionality of vehicle applications performed by a processor (e.g., the processor 164, 303, 304, 306, 307, 308, 310, 317, 430) of a vehicle (e.g., the vehicle 100) at different levels of performance may be correlated to a driver safety quotient through driver testing.

FIG. 5B illustrates allocation illustrating how reducing processing resources to and functionality elements of different types of vehicle applications can result in different application performance delivery rates and different impacts on driving safety quotient or degrees of reduction in driver performance of vehicle safety-related tasks. illustrates examples of driving safety quotient versus performance delivery rate curves for a cluster rendering and display application 522, a lane departure warning application 524, and a navigation application 526. While each vehicle application exhibits a 100% driving safety quotient when operating at 100% of its performance delivery rate, illustrated in points 522a, 524a, 526a, the rate at which driver performance measured in terms of the driver safety quotient is impacted by reductions in the application performance delivery rate can vary significantly. In particular, some applications, such as cluster rendering and display 522, can have a significant impact on driver performance of vehicle safety-related tasks from minor reductions in computing resources allocated to the application, while other applications, such as navigation applications 526, may have minimal impact on driver performance of vehicle safety-related tasks from minor reductions in computing resources allocated to the application.

In various embodiments, the different sensitivity of the safety performance to reductions in computing resources allocated to each application 522, 524, 526 may be used to determine a priority to safe driving task performance of each application. Put another way, each application 522, 524, 526 may permit a different reduction in computer resource allocation before a typical driver's performance of safety-related tasks reaches a particular driver safety quotient. This sensitivity in driver performance or degree of impact on driver performance per unit reduction in computing resources allocated to the application may be reflected in the driver-performance-safety factor attributed to each application.

Said another way, the sensitivity to computing resource allocation to drivers' ability to perform safety-related tasks of each application 522, 524, 526 reflects each application's priority to safe driving-task performance, as well as the degree to which the application's performance delivery rate is impacted by changes in allocated computing resources or changes in application functionality elements. For example, the cluster rendering and display application 522 may generate the display of the speedometer and other information vital to safe driving at nearly all times and in nearly all internal or external vehicle conditions. Thus, a relatively small decrease in computing resource allocated to the cluster rendering and display application 522 May dramatically affect the driver safety quotient. As another example, a lane departure warning application 524 also provides important safety information, but driver performance of the safety-related task or keeping the vehicle in a traffic lane is less sensitive to reductions in computing resource allocated to the lane departure warning application 24. In Put another way, the computing resource allocated to each application 522, 524, 526 may be decreased by different amounts while maintaining a minimum level of driver performance of safety-related tasks measured in terms of a driving safety quotient.

As described herein, the safety performance of each application 522, 524, 526 based on computing resource allocation and based on each application's priority to safe vehicle operations may be known or determined in advance.

FIG. 5C illustrates how the various curves of driver safety quotient versus vehicle application delivery rate (which is related to computing resources allocated to individual vehicle applications) can be applied by a processor of a vehicle computing device to allocate resources to individual vehicle applications in a performance-consistent manner according to various embodiments. FIG. 5D is a process flow diagram illustrating operations of a method for determining allocations of computing resources to individual vehicle applications to achieve an overall reduction in employed computing resources using the relationships illustrated in FIG. 5C. With reference to FIGS. 1A-5D, the method 550 may be may be performed by a processor (e.g., the processor 164, 303, 304, 306, 307, 308, 310, 317, 430) of a vehicle (e.g., the vehicle 100). FIGS. 5C and 5D are addressed together in the following description of the example method 550.

In response to determining that computing resources need to be reduced in block 552, such as in response to detecting a maximum performance threshold or criteria has been reached (e.g., maximum temperature, maximum operating processes, maximum current, etc.), the processor may determine or select a reduction in the driver safety quotient in order to reduce computing resources allocated to vehicle applications in block 554. This is illustrated in the arrow 528 that shows a reduction in relative driver safety performance from 100% to approximately 80% on the percentage scale of the driving safety quotient, illustrated by the dashed line 530. The selection of a new level of driving safety quotient may be based on the amount of reduction in computing resources like processor operating frequency or current estimated to be required to bring in a performance characteristic (e.g., temperature of various components, memory usage, maximum processor operations, etc.) within a corresponding maximum threshold. In some embodiments, the amount of reduction in driving safety quotient may be determined based on a formulaic estimation, such as may be determined through analysis and/or developmental or production testing. In some embodiments, the amount of reduction in driving safety quotient may be estimated using a table lookup process accessing a data table stored in memory was determined through design analysis, developmental testing, and/or product acceptance testing.

In block 556, the processor may use the various curves of driving safety quotient versus application performance delivery rates (e.g., curves 522, 524, 526) to determine for each vehicle application the level of performance delivery rate that will result in the decreased driving safety quotient (dashed line 530). This is illustrated by the open circles where each of the three vehicle application performance curves 522, 524, 526 intersects the decreased driving safety quotient (dashed line 530), indicating the corresponding performance delivery rate for each application, illustrated in the diamonds 522c, 524c, 526c.

In block 558, the processor may allocate computing resources to each of the plurality of vehicle applications by implementing operating parameters or functionality elements that provide the performance delivery rate determined for each application in block 556. As the performance delivery rate of each application may depend upon adjustments to various functionality elements (e.g., as illustrated in FIG. 5A), the operations in block 558 may involve implementing each of the determined operating parameters and/or adjusting or activating/deactivating various functionality elements that will result in the determined performance delivery rate. The change in computing resources allocated to each vehicle application may depend on the impact on processor operations, operating frequency, current, etc. of the changes to functionality elements (e.g. adjustments to the “load control knobs”). So, the processor may also determine the overall change in allocated computing resources resulting from all of the various changes in operating parameters and functionality elements implement across the plurality of vehicle applications to achieve or support the decrease in driving safety quotient. Alternatively, the processor may implement the changes in operating parameters and/or functionality elements required to achieve the determined performance delivery rate for each vehicle application, and then measure or estimate the computing resources allocated to the various applications.

In determination block 560, the processor may determine whether the need to reduce computing resources identified in block 552 has been resolved. For example, if the condition triggering the need to reduce computing resources allocated to vehicle applications was one or more monitored component temperatures exceeding a corresponding temperature threshold, the processor may monitor the complement temperatures to determine whether the temperatures fall below the threshold values.

In response to determining that the need to reduce computing resources identified in block 552 has not been resolved (i.e., determination block 560=“No”), the processor may determine a new reduction in the driver safety quotient in block 554 and repeat the operations of blocks 556 and 558 before repeating the operations in determination block 560. Thus, the processor may iteratively perform the operations of the method 550 until the condition triggering the need to reduce computing resources has been addressed.

In response to determining that the need to reduce computing resources allocated to vehicle applications identified in block 552 has not been resolved (i.e., determination block 560=“Yes”), the processor may continue to monitor operating parameters (e.g., maximum temperature, peak current, processor resource limits, etc.) to detect further needs to reduce computing resources allocated to vehicle applications. In some embodiments, the processor may also monitor operating parameters to detect when computing resources allocated to vehicle applications may be increased, in which case the operations of method 550 may be performed except that in block 552 the processor may determine an increase in driver safety quotient that can be accommodated, after which the processor may perform the operations in blocks 554 and 556 to increase the application performance delivery rate consistent with the increased driving safety quotient.

As illustrated in FIG. 5C, the profile of driving safety quotient as a function of performance delivery rate (which is related to computing resources allocated to various vehicle applications) of various applications can result in the processor identifying different levels of application performance delivery rate to support a selected level of the driving safety quotient. For example, as illustrated in FIG. 5C, reducing the overall driving safety quotient by 20% to approximately 80% (dashed line 530) may be supported by reducing the performance delivery rate of—and thus the computing resources allocated to—the navigation program 526 by a significant amount (approximately 58%), while reducing the overall driving safety quotient by the same amount may be supported by reducing the performance delivery rate of—and thus the computing resources allocated to—the cluster rendering and display application 522 by a small amount (approximately 2%). In other words, to support the same overall driving safety quotient 530, significantly more reductions in computing allocated computing resources to the navigation application 526 is possible, while only a small reduction in computing resources allocated to the cluster rendering and display application 522 may be permitted. Thus, when reducing computing resources allocated to vehicle applications in order for the vehicle computing system to remain within operating limits, the embodiment methods enable individually adjusting the performance delivery rate of various vehicle applications whereas to provide a given level of overall assistance for drivers performing safety related tasks.

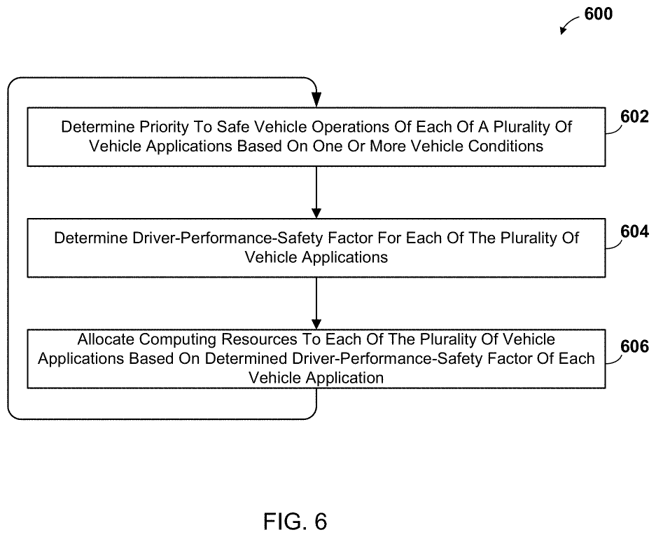

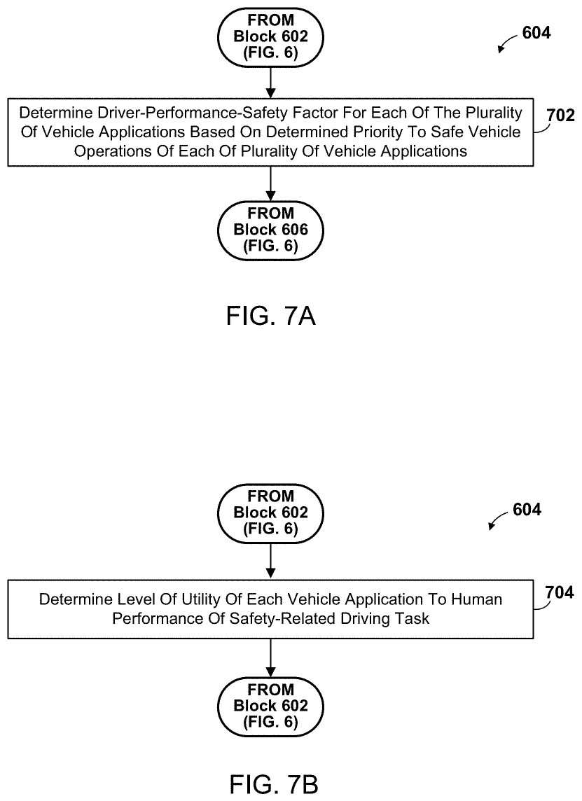

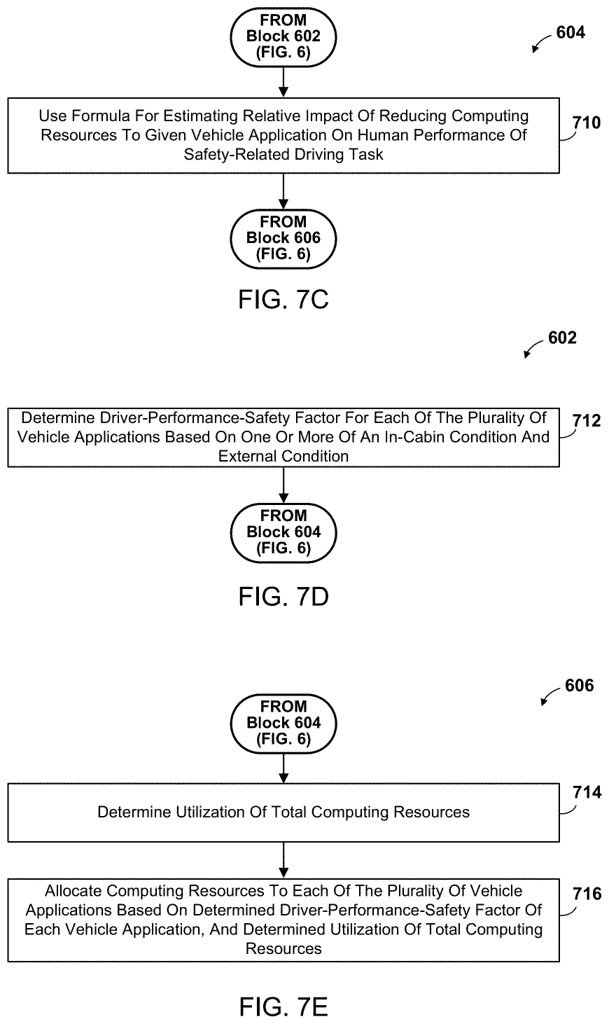

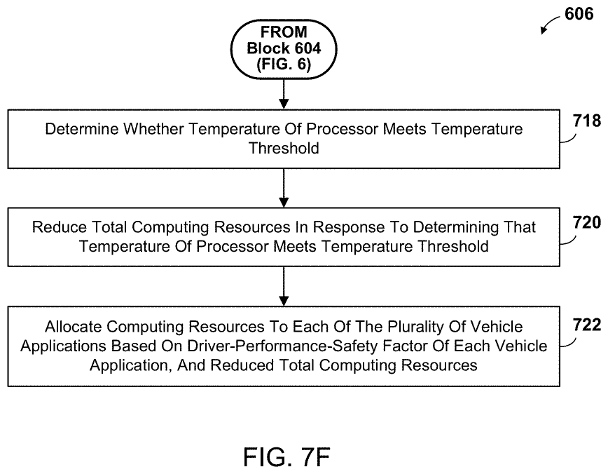

FIG. 6 is a process flow diagram illustrating operations of a method 600 that may be performed by a processor of a vehicle for allocating computing resources to an application in accordance with various embodiments. With reference to FIGS. 1-6, the operations of the method 600 may be performed by a processor (e.g., the processor 164, 303, 304, 306, 307, 308, 310, 317, 430) of a vehicle (e.g., the vehicle 100).

In response to a condition or detection of an event requiring adjusting the allocation of computing resources to vehicle applications (e.g., based on temperature, current, processing load, etc.), the processor may determine a priority to safe vehicle operations of each of the plurality of vehicle applications based on one or more vehicle conditions in block 602. In some embodiments, the one or more vehicle conditions include one or more of an in-cabin condition and an external condition. In some embodiments, the vehicle conditions may include a plurality of vehicle conditions in any combination of in-cabin and external conditions.

In block 604, the processor may determine a driver-performance-safety factor for each of the plurality of vehicle applications. In various embodiments, the driver-performance-safety factor may reflect a predicted relative impact on a safety-related driving task of reducing computing resources to a given vehicle application.

In block 606, the processor may allocate computing resources to each of the plurality of vehicle applications based on determined the driver-performance-safety factor of each vehicle application. As described with reference to FIG. 5A, allocating computing resources to each of the plurality of vehicle applications may involve adjusting one or more of various application parameters or alternatives. For example, allocate computing resources to each of the plurality of vehicle applications may be accomplished by adjusting one or more of display frames per second, display resolution, processing accuracy or resolution, quality of output, algorithms used by the application, or functionality of the application to achieve or accommodate a predetermined level of reduction in processing operations, memory usage, processor frequency, processor current, etc., which are generally and collectively referred to herein as computing resources.

The operations of blocks 602-606 may be repeated periodically or continuously to adjust or reallocate computing resources to various vehicle applications as internal and external conditions change and as available computing resources increase or decrease.

FIG. 7A-7F are process flow diagrams illustrating operations that may be performed by a processor of a vehicle as part of a method for allocating computing resources to an application in accordance with various embodiments. With reference to FIGS. 1-7F, the operations may be performed by a processor (e.g., the processor 164, 303, 304, 306, 307, 308, 310, 317) of a vehicle (e.g., the vehicle 100).

With reference to FIG. 7A, following the operations of block 602 (FIG. 6), the processor may determine the driver-performance-safety factor for each of the plurality of vehicle applications based on the contribution to safe vehicle operations of each of the plurality of vehicle applications in block 702. In some embodiments, the contribution of a vehicle application to safe vehicle operation may affect the change to the driver-performance-safety factor for each application caused by decreasing or reducing computing resource allocation to the vehicle application.

The processor may then perform the operations of block 606 (FIG. 6) as described.

With reference to FIG. 7B, following the operations of block 602 (FIG. 6), the processor may determine a level of utility of each vehicle application to human performance of the safety-related driving task in block 704. For example, as illustrated in FIG. 5, the driver-performance-safety factor of different applications may be affected differently by a similar decrease in computing resource allocation.

The processor may then perform the operations of block 606 (FIG. 6) as described.

With reference to FIG. 7C, following the operations of block 602 (FIG. 6), the processor may use a formula for estimating the relative impact of reducing computing resources to a given vehicle application on human performance of the safety-related driving task in block 710. As noted above, in some embodiments the formula may be represented as Xᵢ=functionᵢ (Pᵢ, Cᵢ).

In some embodiments, the processor may generate the formula, or the formula may be generated prior to execution by the processor, by determining a formula that encompasses relative impacts on human performance of the safety-related driving task at a plurality of different levels of reduced computing resources for a plurality of drivers. For example, as illustrated in FIG. 5, the driver-performance-safety factor of different applications may be affected differently by a similar decrease in computing resource allocation.

The processor may then proceed to perform the operations of block 606 (FIG. 6) as described.

With reference to FIG. 7D, the processor may determine a priority of each of the plurality of vehicle applications based on one or more of an in-cabin condition and an external condition in block 712. In some embodiments, the processor may determine (or re-determine) the priority of each of the plurality of vehicle applications from time to time, periodically, and/or a change in one or more in-cabin or external conditions.

The processor may then proceed to perform the operations of block 604 (FIG. 6) as described.

With reference to FIG. 7E, following the operations of block 604 (FIG. 66), the processor may determine a utilization of total computing resources in block 714. In some embodiments, the processor may determine a level utilization of one or more processors of the vehicle (such as processor cycles, bandwidth, or another metric of processor utilization). In some embodiments, the processor may determine a surplus or shortage of computing resources.

In block 716, the processor may allocate computing resources to each of the plurality of vehicle applications based on determined the driver-performance-safety factor of each vehicle application, and the determined utilization of total computing resources. As described with reference to FIG. 5A, allocating computing resources to each of the plurality of vehicle applications may involve adjusting one or more of various application parameters or alternatives. For example, allocate computing resources to each of the plurality of vehicle applications may be accomplished by adjusting one or more of display frames per second, display resolution, processing accuracy or resolution, quality of output, algorithms used by the application, or functionality of the application to achieve or accommodate a predetermined level of reduction in allocated computing resources (e.g., processing operations, memory usage, processor frequency, processor current, etc.).

In some embodiments, as one or more in-cabin or external conditions change, a total utilization of computing resources implemented in block 716 may change. In some embodiments, a total utilization of computing resources may change based on a required shift in resource allocation from application to application, which may depend on changing in-cabin or external conditions.

With reference to FIG. 7F, following the operations of block 604 (FIG. 6), the processor may determine whether a temperature of the processor meets a temperature threshold in block 718. For example, the processor may determine that the processor is approaching or has met of thermal limit or other temperature threshold.

In block 720, the processor may reduce the total computing resources in response to determining that the temperature of the processor meets the temperature threshold.

In block 722, the processor may allocate allocating computing resources to each of the plurality of vehicle applications based on the determined driver-performance-safety factor of each vehicle application, and the reduced total computing resources. As described with reference to FIG. 5A, allocating computing resources to each of the plurality of vehicle applications may involve adjusting one or more of various application parameters or functionality elements. For example, allocate computing resources to each of the plurality of vehicle applications may be accomplished by adjusting one or more of display frames per second, display resolution, processing accuracy or resolution, quality of output, algorithms used by the application, or functionality of the application to achieve or accommodate a predetermined level of reduction in allocated computing resources (e.g., processing operations, memory usage, processor frequency, processor current, etc.).

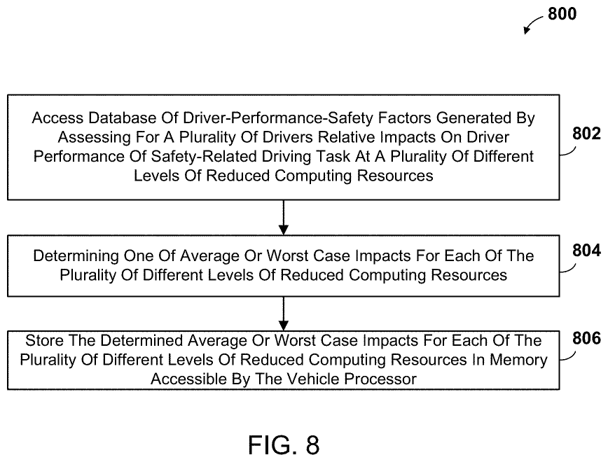

FIG. 8 is a process flow diagram illustrating an example method 800 for developing a database of driver-performance-safety factors for each of plurality of vehicle applications. With reference to FIGS. 1-8, the method 800 may be performed by testing a number of drivers of different backgrounds, driving skill levels, different ages etc. tested in vehicles or vehicle simulators that are configured to measure relative performance of each driver of safety-related tasks while various vehicle applications are allocated varying levels of computing resources, and correlating results in terms of driver safety quotient to different levels of vehicle application performance delivery rates.

In block 802, a testing facility or authority may assess for the plurality of drivers the relative impact on driver performance of one or more safety-related driving tasks as each of the plurality of vehicle applications are allocated a plurality of different levels of computing resources. As described with reference to FIG. 5A, achieving different levels of computing resources allocated to each of the plurality of vehicle applications may involve adjusting one or more of various application parameters or functionality elements. For example, allocating computing resources to each of the plurality of vehicle applications may be accomplished by adjusting one or more of display frames per second, display resolution, processing accuracy or resolution, quality of output, algorithms used by the application, or functionality of the application to achieve or accommodate a predetermined overall level of reduction in processing operations, memory usage, processor frequency, processor current, etc. As part of vehicle application creation and testing, application developers may determine or select how each of the alternative adjustments are implemented so as to achieve or accommodate various reductions in allocated computing resources. The determined or selected various ways of achieving or accommodating different allocations of computing resources may then be implemented in the driver performance testing.

In some embodiments, as part of the operations in block 802, different interior and exterior vehicle conditions may be set or simulated (e.g., back ground noise, rain on the windshield, road conditions, vehicle speed, etc.), and each drivers performance under the varied condition for each application at each resource allocation may be recorded.

In block 804, the results of the driver performance testing in block 802 may be analyzed to determine one of an average or a worst-case impact on driver performance of safety-related tasks for each of the plurality applications at each of the different levels of allocated computing resources. In some embodiments, this analysis may also take into consideration driver performance under varied conditions for each application at each resource allocation, such as to determine a condition-adjustment factor or other metric for each average or worst-case impact determination. Any form of data analysis may be performed to determine impact levels that are suitable for predicting the impact on a given or average driver's performance from reducing computing resources to each vehicle application.

In block 806, the determined average or worst-case impact on driver performance of safety-related tasks for each of the plurality applications at each of the different levels of allocated computing resources may be stored in memory, such as in the form of a data table, look up table, or the like. For example, such a data table or look up table may be stored in memory of a vehicle computing system where the data can be accessed by a processor when determining how to allocate computing resources to various vehicle applications, such as in the method 600 as described. In some embodiments, the average or worst-case impact on driver impact on driver performance of safety-related tasks for each of the plurality applications at each of the different levels of allocated computing resources may be expanded to address or include the relative impact as a function of various interior and exterior conditions as measured during the driver testing in block 802. In some embodiments, the average or worst-case impact on driver impact on driver performance of safety-related tasks for each of the plurality applications at each of the different levels of allocated computing resources, as well as different interior and exterior conditions, may be converted into an equation, such as through a least squares fit or other curve fitting method, and the resulting equation stored in memory in block 806.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The foregoing method descriptions and the process flow diagrams are provided merely as illustrative examples and are not intended to require or imply that the blocks of various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of various embodiments.

The hardware used to implement the various illustrative logics, logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of communication devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In various embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present embodiments. Various modifications to these embodiments will be readily apparent to those skilled in the art, and the generic principles defined herein may be applied to other embodiments without departing from the scope of the embodiments. Thus, various embodiments are not intended to be limited to the embodiments shown herein but are to be accorded the widest scope consistent with the following claims and the principles and novel features disclosed herein.

What is claimed is:

1. A method of allocating computing resources to an application performed by a processor of a vehicle, comprising:
determining a driver-performance-safety factor for each of a plurality of vehicle applications, wherein the driver-performance-safety factor reflects a predicted relative impact on a safety-related driving task of reducing computing resources to a given vehicle application; and
allocating computing resources to each of the plurality of vehicle applications based on the determined driver-performance-safety factor of each vehicle application.

2. The method of claim 1, wherein determining the driver-performance-safety factor for each of the plurality of vehicle applications comprises determining the driver-performance-safety factor for each of the plurality of vehicle applications based on a priority to safe vehicle operations of each of the plurality of vehicle applications.

3. The method of claim 1, wherein determining the driver-performance-safety factor for each of the plurality of vehicle applications comprises determining a level of utility of each vehicle application to human performance of the safety-related driving task.

4. The method of claim 1, wherein:
determining the driver-performance-safety factor for each of the plurality of vehicle applications comprises:
determining a reduced overall driving safety quotient; and
determining for each of the plurality of vehicle applications a performance delivery rate for the application that satisfies the reduced overall driving safety quotient; and
allocating computing resources to each of the plurality of vehicle applications comprises implementing in each of the plurality of vehicle applications operating parameters and functionality elements that provide the performance delivery rate for each vehicle application.

5. The method of claim 1, wherein determining the driver-performance-safety factor for each of the plurality of vehicle applications comprises:
accessing a database of driver-performance-safety factors generated by assessing, for a plurality of drivers, relative impacts on driver performance of the safety-related driving task at a plurality of different levels of reduced computing resources; and
determining one of average or worst-case impacts for each of the plurality of different levels of reduced computing resources.

6. The method of claim 1, wherein determining the driver-performance-safety factor for each of the plurality of vehicle applications comprises using a formula for estimating a relative impact of reducing computing resources to a given vehicle application on human performance of the safety-related driving task, wherein the formula is generated by determining a formula that encompasses relative impacts on human performance of the safety-related driving task at a plurality of different levels of reduced computing resources for a plurality of drivers.

7. The method of claim 1, wherein the one or more vehicle conditions include one or more of an in-cabin condition and an external condition.

8. The method of claim 7, wherein determining the driver-performance-safety factor for each of the plurality of vehicle applications comprises determining the driver-performance-safety factor for each of the plurality of vehicle applications based on one or more of an in-cabin condition and an external condition.

9. The method of claim 1, further comprising:
determining a utilization of total computing resources;
wherein allocating computing resources to each of the plurality of vehicle applications comprises allocating computing resources to each of the plurality of vehicle applications based on the determined driver-performance-safety factor of each vehicle application, and the determined utilization of total computing resources.

10. The method of claim 1, further comprising:
determining whether a temperature of the processor meets a temperature threshold; and
reducing total computing resources in response to determining that the temperature of the processor meets the temperature threshold,
wherein allocating computing resources to each of the plurality of vehicle applications comprises allocating computing resources to each of the plurality of vehicle applications based on the determined driver-performance-safety factor of each vehicle application, and the reduced total computing resources.

11. A vehicle, comprising:
a processing device configured with processor-executable instructions to:
determine a driver-performance-safety factor for each of a plurality of vehicle applications, wherein the driver-performance-safety factor reflects a predicted relative impact on a safety-related driving task of reducing computing resources to a given vehicle application; and
allocate computing resources to each of the plurality of vehicle applications based on the determined driver-performance-safety factor of each vehicle application.

12. The vehicle of claim 11, wherein the processing device is further configured with processor-executable instructions to determine the driver-performance-safety factor for each of the plurality of vehicle applications by determining the driver-performance-safety factor for each of the plurality of vehicle applications based on a priority to safe vehicle operations of each of the plurality of vehicle applications.

13. The vehicle of claim 11, wherein the processing device is further configured with processor-executable instructions to determine the driver-performance-safety factor for each of the plurality of vehicle applications by determining a level of utility of each vehicle application to human performance of the safety-related driving task.

14. The vehicle of claim 11, wherein the processing device is further configured with processor-executable instructions to:
determine the driver-performance-safety factor for each of the plurality of vehicle applications by:
determining a reduced overall driving safety quotient; and
determining for each of the plurality of vehicle applications a performance delivery rate for the application that satisfies the reduced overall driving safety quotient; and
allocate computing resources to each of the plurality of vehicle applications by implementing in each of the plurality of vehicle applications operating parameters and functionality elements that provide the performance delivery rate for each vehicle application.

15. The vehicle of claim 11, wherein the processing device is further configured with processor-executable instructions to determine the driver-performance-safety factor for each of the plurality of vehicle applications by:
accessing a database of driver-performance-safety factors generated by assessing, for a plurality of drivers, relative impacts on driver performance of the safety-related driving task at a plurality of different levels of reduced computing resources; and
determining one of average or worst-case impacts for each of the plurality of different levels of reduced computing resources.

16. The vehicle of claim 11, wherein the processing device is further configured with processor-executable instructions to determine the driver-performance-safety factor for each of the plurality of vehicle applications by using a formula for estimating a relative impact of reducing computing resources to a given vehicle application on human performance of the safety-related driving task.

17. The vehicle of claim 11, wherein the processing device is further configured with processor-executable instructions to determine the driver-performance-safety factor for each of the plurality of vehicle applications based on one or more of an in-cabin condition and an external condition.

18. The vehicle of claim 11, wherein the processing device is further configured with processor-executable instructions to determine a utilization of total computing resources,
wherein the processing device is further configured with processor-executable instructions to allocate computing resources to each of the plurality of vehicle applications by allocating computing resources to each of the plurality of vehicle applications based on the determined driver-performance-safety factor of each vehicle application, and the determined utilization of total computing resources.

19. The vehicle of claim 11, wherein the processing device is further configured with processor-executable instructions to:
determine whether a temperature of the processor meets a temperature threshold; and
reduce total computing resources in response to determining that the temperature of the processor meets the temperature threshold,
wherein the processing device is further configured with processor-executable instructions to allocate computing resources to each of the plurality of vehicle applications by allocating computing resources to each of the plurality of vehicle applications based on the determined driver-performance-safety factor of each vehicle application, and the reduced total computing resources.

20. A computing device configured for use in a vehicle, comprising:
a processing device configured with processor-executable instructions to:
determine a driver-performance-safety factor for each of a plurality of vehicle applications, wherein the driver-performance-safety factor reflects a predicted relative impact on a safety-related driving task of reducing computing resources to a given vehicle application; and
allocate computing resources to each of the plurality of vehicle applications based on the determined the driver-performance-safety factor of each vehicle application.

21. The computing device of claim 20, wherein the processing device is further configured with processor-executable instructions to determine the driver-performance-safety factor for each of the plurality of vehicle applications by determining the driver-performance-safety factor for each of the plurality of vehicle applications based on a priority to safe vehicle operations of each of the plurality of vehicle applications.

22. The computing device of claim 20, wherein the processing device is further configured with processor-executable instructions to determine the driver-performance-safety factor for each of the plurality of vehicle applications by determining a level of utility of each vehicle application to human performance of the safety-related driving task.

23. The computing device of claim 20, wherein the processing device is further configured with processor-executable instructions to:
determine the driver-performance-safety factor for each of the plurality of vehicle applications by:
determining a reduced overall driving safety quotient; and
determining for each of the plurality of vehicle applications a performance delivery rate for the application that satisfies the reduced overall driving safety quotient; and
allocate computing resources to each of the plurality of vehicle applications by implementing in each of the plurality of vehicle applications operating parameters and functionality elements that provide the performance delivery rate for each vehicle application.

24. The computing device of claim 20, wherein the processing device is further configured with processor-executable instructions to determine the driver-performance-safety factor for each of the plurality of vehicle applications by:
accessing a database of driver-performance-safety factors generated by assessing, for a plurality of drivers, relative impacts on driver performance of the safety-related driving task at a plurality of different levels of reduced computing resources; and
determining one of average or worst-case impacts for each of the plurality of different levels of reduced computing resources.

25. The computing device of claim 20, wherein the processing device is further configured with processor-executable instructions to determine the driver-performance-safety factor for each of the plurality of vehicle applications by using a formula for estimating a relative impact of reducing computing resources to a given vehicle application on human performance of the safety-related driving task.

26. The computing device of claim 20, wherein the processing device is further configured with processor-executable instructions to determine the driver-performance-safety factor for each of the plurality of vehicle applications based on one or more of an in-cabin condition and an external condition.

27. The computing device of claim 20, wherein the processing device is further configured with processor-executable instructions to determine a utilization of total computing resources,
wherein the processing device is further configured with processor-executable instructions to allocate computing resources to each of the plurality of vehicle applications by allocating computing resources to each of the plurality of vehicle applications based on the determined driver-performance-safety factor of each vehicle application, and the determined utilization of total computing resources.

28. The computing device of claim 20, wherein the processing device is further configured with processor-executable instructions to:
determine whether a temperature of the processor meets a temperature threshold; and
reduce total computing resources in response to determining that the temperature of the processor meets the temperature threshold,
wherein the processing device is further configured with processor-executable instructions to allocate computing resources to each of the plurality of vehicle applications by allocating computing resources to each of the plurality of vehicle applications based on the determined driver-performance-safety factor of each vehicle application, and the reduced total computing resources.

29. A non-transitory processor-readable medium having stored thereon processor-executable instructions configured to cause a computing device of a vehicle to perform operations comprising:
determining a driver-performance-safety factor for each of a plurality of vehicle applications executing in the computing device, wherein the driver-performance-safety factor reflects a predicted relative impact on a safety-related driving task of reducing computing resources to a given vehicle application; and
allocating computing resources to each of the plurality of vehicle applications based on the determined driver-performance-safety factor of each vehicle application.

30. The non-transitory processor-readable medium of claim 29, wherein the stored processor-executable instructions are configured to cause the computing device of the vehicle to perform operations such that:
determining the driver-performance-safety factor for each of the plurality of vehicle applications comprises:
determining a reduced overall driving safety quotient; and
determining for each of the plurality of vehicle applications a performance delivery rate for the application that satisfies the reduced overall driving safety quotient; and
allocating computing resources to each of the plurality of vehicle applications comprises implementing in each of the plurality of vehicle applications operating parameters and functionality elements that provide the performance delivery rate for each vehicle application.
